(19) United States
(12) Patent Application Publication
(10) Pub. No.: US 2003/0200119 A1
(43) Pub. Date: Oct. 23, 2003

(54) Method and system for accessing healthcare information using an anatomic user interface

(75) Inventors: Gregory P. Lewis, Seattle, WA (US); James D. Glasgow, Burien, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MedOrder, Inc.

(21) Appl. No.: 10/456,656

(22) Filed: Jun. 5, 2003

Related U.S. Application Data
(63) Continuation of application No. 09/523,569, filed on Mar. 10, 2000, now abandoned.

(51) Int. Cl. G06F 17/60

(52) U.S. Cl. 705/2

(57) ABSTRACT

An anatomic user interface (58) is provided for accessing healthcare information for a patient at the point of care. The anatomic user interface (58) generates an anatomic model (402) of the patient from which a practitioner drills down to and selects a particular anatomic structure for which healthcare information is to be accessed. The anatomic user interface obtains standard reference anatomic information and patient-specific anatomic information from an anatomic data model (84) and uses this information to generate an anatomic model (402) that accurately represents the anatomy of the patient. Once the practitioner selects a particular anatomic structure of the patient, a constraint engine (82) identifies the healthcare information associated with the selected anatomic structure as constrained by outside factors impacting accepted medical practice and returns it to the anatomic user interface (58) for display. In one actual embodiment of the present invention, the healthcare information accessed by the practitioner is healthcare diagnosis and services information. In this embodiment, the practitioner uses the anatomic user interface (58) to drill down to a particular anatomic structure of the patient and order healthcare services to be applied to the structure. The order is then forwarded to a service provider via an order engine (86).

### CROSS-REFERENCE TO RELATED APPLICATION

This application is a continuation of prior application Ser. No. 09/523,569, filed Mar. 10, 2000, priority from the filing date of which is hereby claimed under 35 U.S.C. § 120, and which is hereby incorporated by reference.

### FIELD OF THE INVENTION

This invention generally relates to accessing healthcare information and, more specifically, to a method and system for accessing healthcare information using a graphical user interface to the human anatomy, that enables a user to drill down to an anatomic structure of interest from a high-level anatomic model and retrieve the healthcare information associated with that anatomic structure.

### BACKGROUND OF THE INVENTION

The modern healthcare delivery system often involves many independent participants including patients, primary physicians, specialists, technicians, pharmacists, nurses, hospitals and insurance companies. In the traditional healthcare delivery model, a patient presents for services, a physician performs a history and evaluation of the patient, possibly orders diagnostic tests, later retrieves test results, determines a diagnosis and prescribes treatment. This model requires the physician and the other participants of the healthcare delivery system to frequently access healthcare information so that the patient may be properly evaluated, diagnostic tests may properly be ordered, test results properly reviewed, diagnoses properly determined, and treatments properly prescribed. The healthcare information necessary for implementing this model is found in all kinds of disparate sources, from medical reference books to computerized medical databases, insurer bulletins, medication formularies and everything in between. Accessing and retrieving information from disparate sources to construct the information required for many healthcare processes such as ordering tests is an arduous, error-prone, manual process, and is a major source of administrative costs in the delivery of healthcare. Accessing information from disparate sources complicates the healthcare delivery process because the information required is not organized in a consistent workflow context.

One aspect of the modern healthcare delivery system which is most impacted by the participants' need to access healthcare information is the reimbursement process for healthcare services. With the ascendancy of government insurance programs such as Medicare, the healthcare services industry has adopted a de facto standard of coding for describing healthcare services and the reasons for providing such healthcare services. For example, the Healthcare Financing Administration (“HCFA”) has published a set of universally accepted codes for identifying medical diagnoses, classifying morbidity and mortality information, and indexing hospital records by disease and operation. These codes are known as ICD9 codes and are set forth in the International Classification of Disease, 9^{th} Edition. In addition, the American Medical Association (“AMA”) has promulgated a set of codes for identifying healthcare services and procedures performed by physicians. These codes are known as Current Procedural Terminology (“CPT”) codes and are used to provide a uniform language that accurately describes medical, surgical and diagnostic services, thereby providing an effective means of communication in today's healthcare delivery system. The CPT system is the most widely accepted system for the reporting of procedures and healthcare services under government and private health insurance programs.

In theory, by using these ICD9 and CPT codes, a properly coded order should navigate the modern healthcare delivery system with little difficulty. However, the reality is that the order is often not properly coded or constructed. Coding is often treated retrospectively after service delivery, often utilizing a manual review of incomplete records. Further, the communication of orders between participants is often an inefficient, error-prone process, utilizing printed forms, frequent phone messages, scribbled notes and faxed instructions, frequently without proper coding. The result is rejected claims, expensive rework by the participant or insurer, and sometimes, delay of service delivery to the patient. Even if orders for healthcare services are coded properly at initiation, there are additional burdens of complying with frequent code changes and additional regulatory requirements such as the Health Insurance Portability and Accountability Act (“HIPAA”). Many of these requirements vary by insurer.

Consequently, what is needed is an intuitive, computer-based system and method for quickly and easily accessing healthcare information at the point of care and organized to facilitate making an informed and appropriate healthcare decision. The system and method should facilitate proper encoding of healthcare information to meet regulatory reimbursement requirements, and other industry promulgated requirements. Further, in at least one embodiment, the system and method should enable a user to create properly coded orders for healthcare services which comply with healthcare regulations and facilitate the delivery of healthcare services to patients. In addition, the system and method should take advantage of electronic Internet communication to securely transmit healthcare information to disparate participants. As explained in the following, the present invention provides a method and system that meet these criteria and solves other problems in the prior art.

### SUMMARY OF THE INVENTION

The present invention solves the above-described problems by providing accessing to healthcare information for a patient via an anatomic user interface. The anatomic user interface provides the user with an anatomic model of the patient from which the user may drill down to a particular anatomic structure of interest. Upon selection of the anatomic structure, the anatomic user interface displays to the user the healthcare information that is associated with the selected anatomic structure.

The anatomic user interface displays an anatomic model of the patient using anatomic information provided by an anatomic data model. More specifically, the anatomic data model provides the anatomic user interface with standard reference information describing the normal human anatomy, and patient-specific information describing differences between the normal human anatomy and the anatomy of a particular patient. Consequently, the anatomic user interface displays by the anatomic model with any patient-specific differences from the normal anatomy, e.g., with an extra finger, without an appendix, etc.

In addition, the anatomic data model provides the anatomic user interface with only that healthcare information that associated with a particular anatomic structure, thereby eliminating information related to other non-selected anatomic structures. Consequently, when a particular anatomic structure is selected by the practitioner, only that healthcare information which is associated with it is provided to and displayed to the user by the anatomic user interface.

The healthcare information associated with a particular anatomic structure may further be constrained by outside elements which affect accepted medical practice. For example, if the healthcare information being accessed by the user is healthcare services information used to treat a particular anatomic structure, such healthcare services are constrained by the medical diagnoses that have been attributed to a particular anatomic structure. In addition, the healthcare services which may be provided to a patient may further be constrained by payer, information, service provider capabilities, local best practices, evidence based medicine standards, regulatory requirements, etc. Consequently, in accordance with another aspect of the present invention, a constraint engine is provided which identifies the healthcare information associated with the selected anatomic structure as constrained by outside elements impacting accepted medical practice. Accordingly, the anatomic user interface, anatomic data model and constraint engine together eliminate irrelevant healthcare information and provide the practitioner with only a subset of relevant, more easily navigable information.

In one actual embodiment of the present invention, the healthcare information desired by the practitioner is healthcare diagnosis and service information. Accordingly, the practitioner uses the anatomic user interface to drill down from the anatomic model to a particular surface or internal anatomic structure of interest, and orders healthcare services for the anatomic structure. Thus, in addition to the anatomic user interface, anatomic data model and constraint engine, this embodiment of the present invention also provides an order engine for submitting an order to a service provider for the healthcare services selected by the practitioner using the anatomic user interface. Since the practitioner is only provided with those healthcare services that have been limited to a particular anatomic structure and properly constrained, the order placed by the practitioner is automatically well-formed and properly coded.

In accordance with yet other aspects of the present invention, a method and computer-based system are also provided for accessing healthcare information as described above.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a representative portion of the Internet;

FIG. 2 is a block diagram showing an illustrative operating environment for implementing the present invention;

FIG. 3A is a block diagram depicting an illustrative architecture for a user computer that is used to order healthcare services via an anatomic user interface formed in accordance with the present invention;

FIG. 3B is a block diagram depicting an illustrative architecture for a Web server that is used to provide the user computer with the anatomic user interface;

FIG. 3C is a block diagram depicting an illustrative architecture for an application server that is used to process an order for healthcare services submitted by the user computer;

FIG. 3D is a block diagram depicting an illustrative architecture for a database server, which contains anatomic and patient data used to support the anatomic user interface;

FIGS. 4A-4G depict illustrative windows produced by the anatomic user interface and displayed by a Web browser installed on the user computer;

FIGS. 5A-5C are a flowchart illustrating the logic used by the anatomic user interface to enable a user to order healthcare services;

FIG. 6 is a flow chart illustrating the logic used by a subroutine of the anatomic user interface to enable a user to drill down from a high-level model of the human anatomy to a specific anatomic structure for which healthcare services are to be ordered;

FIG. 7 is a flow chart illustrating the logic used by a subroutine of the anatomic user interface to retrieve a specific anatomic structure;

FIG. 8 is a block diagram depicting an anatomy data model used to organize medical information based on the human anatomy;

FIG. 9 is a block diagram depicting a relationship between anatomic structures within the anatomic data model;

FIG. 10 is a flow chart depicting the logic used by the application server to determine which healthcare services are available for order for a specific anatomic structure having a particular diagnosis;

FIG. 11 is a block diagram of a tree structure representing a hierarchical grouping of possible diagnoses used to determine which healthcare services are available for order;

FIG. 12 is a block diagram of a diagnostic procedure constraint model used to represent a constraint relationship between diagnoses and healthcare services; and

FIG. 13 is a flow chart illustrating the logic used by the application server to process an order for healthcare services.

### DETAILED DESCRIPTION OF THE PREFERRED EMBODIMENT

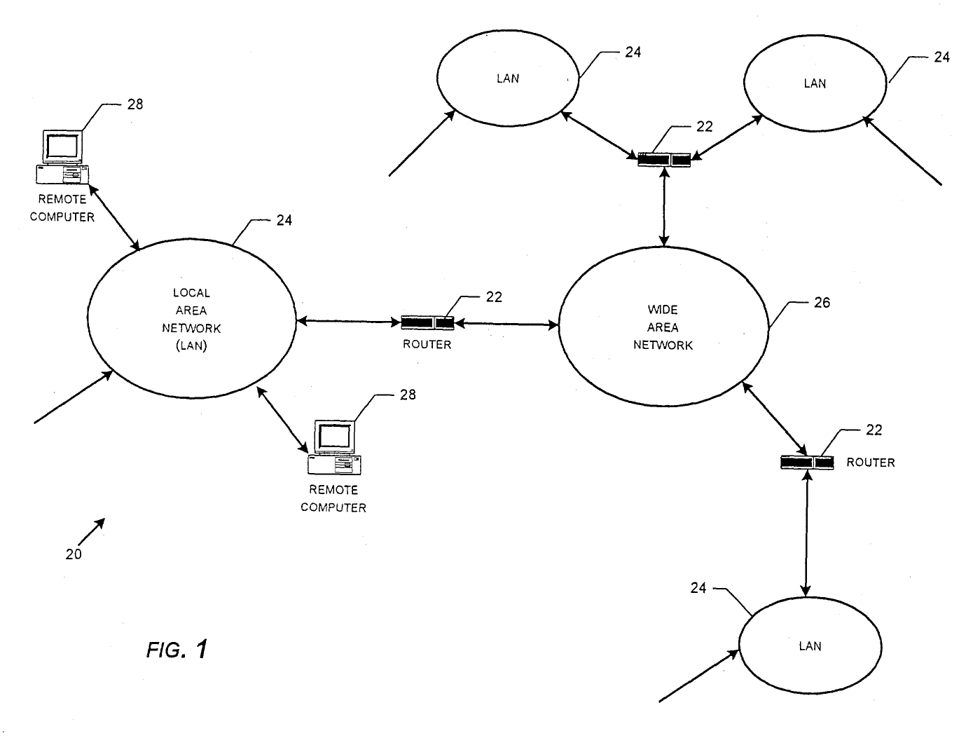

FIG. 1 illustrates a representative portion of the Internet 20. As is well known to those skilled in the art, the term “Internet” refers to the collection of networks and routers that use the Transmission Control Protocol/Internet Protocol (“TCP/IP”) to communicate with one another. In the representative portion of the Internet 20 shown in FIG. 1, a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, or coaxial cable, while communication links between networks may utilize 56 Kbps analog telephone lines, 1 Mbps digital T-1 lines, 45 Mbps T-3 lines or other communications links known to those skilled in the art. Furthermore, computers and other related electronic devices may be remotely connected to either the LANs 24 or the WAN 26 via a modem and temporary phone link. It will be appreciated that the Internet 20 comprises a vast number of such interconnected networks, computers and routers, and that only a small, representative portion of the Internet is shown in FIG. 1.

The Internet 20 has recently seen explosive growth by virtue of its ability to link computers located throughout the world. As the Internet has grown, so has the World Wide Web (“WWW” or the “Web”). As is appreciated by those of ordinary skill in the art, the Web is a vast collection of interconnected or “hypertext” documents (also known as “Web pages”), written in HyperText Markup Language (“HTML”), or other markup languages, that are electronically stored at “Websites” throughout the Internet. A Website is a server connected to the Internet 20 that has mass storage facilities for storing hypertext documents and that runs administrative software for handling requests for those stored hypertext documents. A hypertext document normally includes a number of hyperlinks, i.e., highlighted portions of text which link the document to another hypertext document possibly stored at a Website elsewhere on the Internet. Each hyperlink is associated with a Uniform Resource Locator (“URL”) that provides the exact location of the linked document on a server connected to the Internet and described the document. Thus, whenever a hypertext document is retrieved from any Web server, the document is considered to be retrieved from the WWW. As is known to those of ordinary skill in the art, a Web server may also include facilities for storing and transmitting application programs, such as applications written in the JAVA® programming language from Sun Microsystems, for execution on a remote computer. Likewise, a Web server may also include facilities for executing scripts and other application programs on the Web server itself.

A remote user may retrieve hypertext documents from the WWW via a Web browser application program. A Web browser, such as Netscape's NAVIGATOR® or Microsoft's INTERNET EXPLORER® is a software application for providing a graphical user interface to the WWW. Upon request from the user via the Web browser, the Web browser accesses and retrieves the desired hypertext document from the appropriate Web server using the URL for the document and a protocol known as HyperText Transfer Protocol (“HTTP”). HTTP is a higher-level protocol than TCP/IP and is designed specifically for the requirements of the WWW. It is used on top of TCP/IP to transfer hypertext documents between servers and clients. The Web browser may also retrieve application programs from the Web server, such as JAVA Applets, for execution on the user's computer.

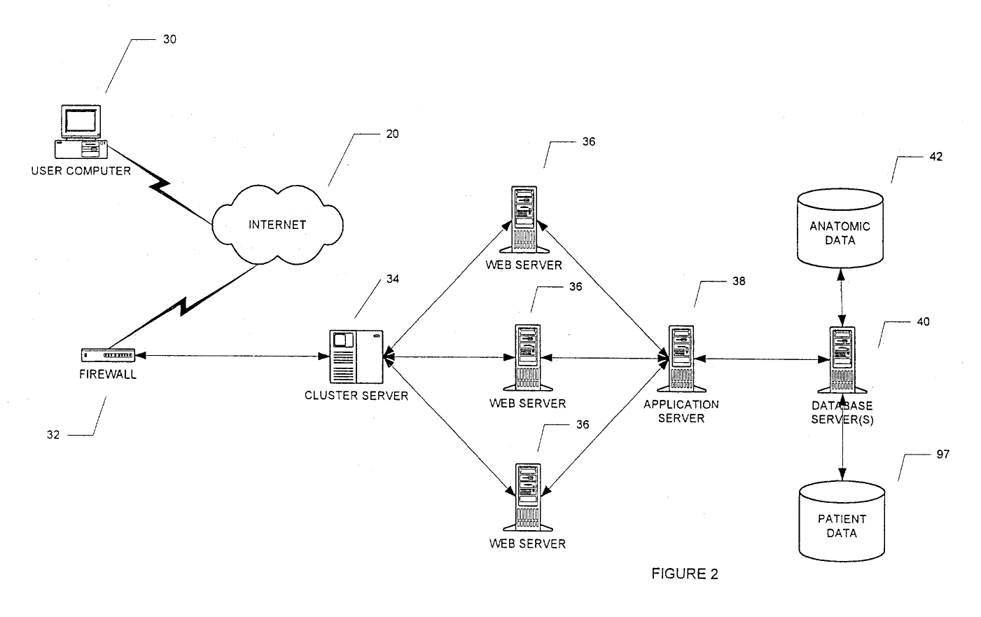

As will be described in more detail below, a healthcare practitioner or other remote user may access healthcare information over the Internet 20 via an anatomic user interface 58 provided by an Internet Website 36. As shown in FIG. 2, a user computer 30 connects to the Internet 20 through a modem or other type of connection. As is known to those skilled in the art, user computer 30 may comprise a general-purpose personal computer capable of executing a Web browser. User computer 30 may also comprise another type of computing device, such as a palm-top computer, a cellphone, personal digital assistant, and the like. Once connected to the Internet 20, a user computer 30 may utilize a Web browser 54 to visit a Web server 36 which provides an anatomic user interface 58 for accessing healthcare information in accordance with the present invention. As will be described in more detail below, the practitioner uses the anatomic user interface 58 to drill down to specific healthcare information and retrieves the information from an application server 38 connected elsewhere to the Internet 20. In one actual embodiment of the present invention, the healthcare information desired by the user is healthcare diagnosis and service information for which the user places an order via the Internet 20. The order is then processed by the application server 38.

As also shown in FIG. 2, the application server 38 and Web server 36 are insulated from the Internet 20 by a firewall server 32 which tracks and controls the flow of all data passing through it using the TCP/IP protocol. The firewall 32 provides protection from malicious in-bound data traffic from the Internet. The firewall 32 is connected to a cluster server 34 which balances the workload of a plurality of Web servers 36, each of which can provide the anatomic user interface 58 of the present invention to users of the Internet 20. Each Web server 36 is then connected to the application server 38 which provides the information requested by the user using the anatomic user interface 58.

The application server 38 is operatively connected to a database server 40 which maintains an anatomic database 42 for storing anatomic data and a patient database 97 for storing patient information. Those skilled in the art should appreciate that the anatomic database 42 and patient database 97 may be stored on a separate database server 40 as shown in FIG. 2, or locally on the application server 38 without departing from the scope of the present invention. Further, in one actual embodiment of the present invention, the firewall 32, cluster server 34, Web servers 36, application server 38 and database server 40 are interconnected by a bus network. The bus network can be formed of various coupling media, such as glass or plastic fiberoptic cables, coaxial cables, twisted wire pair cables, ribbon cables, etc. In addition, one of ordinary skill in the art will appreciate that the coupling medium could also include a radio frequency coupling media or other intangible coupling media. Further, any computer system or number of computer systems, including but not limited to work stations, personal computers, laptop computers, servers, remote computers, etc., that is equipped with the necessary interface hardware may be connected temporarily or permanently to the operating environment shown in FIG. 2, and thus, the Internet 20. Finally, those of ordinary skill in the art will recognize that while only one application server 38, one database server 40, and a few Web servers 36 are depicted in FIG. 2, numerous Web servers, application servers and database serves formed in accordance with the present invention and equipped with the hardware and software structures necessary for connecting to each other and the Internet 20 may be provided.

Relevant User Computers Web Server, Application Server and Database Server Components

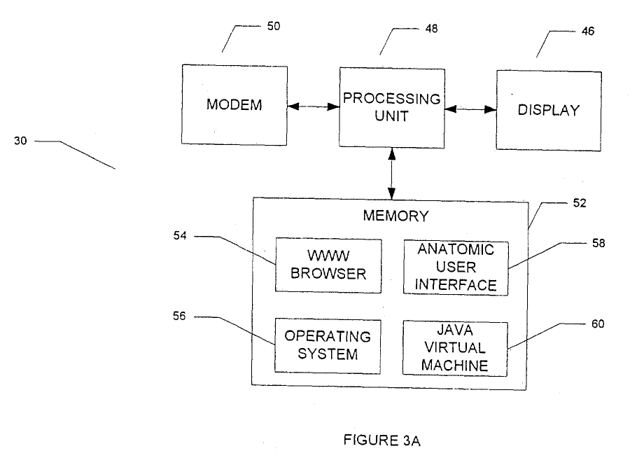

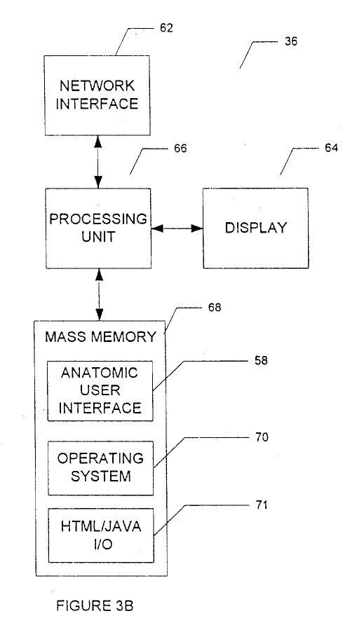

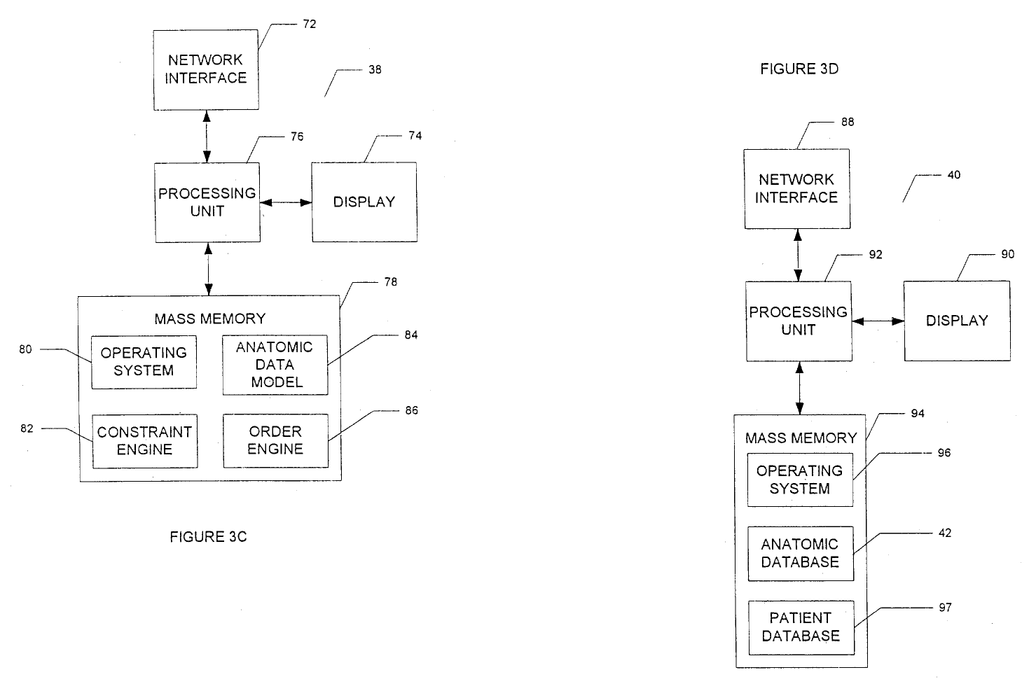

FIG. 3A depicts several of the key components of user computer 30. Those of ordinary skill in the art will appreciate that the user computer 30 includes many more components than those shown in FIG. 3A. However, it is not necessary that all of these generally conventional components be shown in order to disclose an actual embodiment for practicing the present invention. As shown in FIG. 3A, the user computer 30 includes a modem 50 for connecting to the Internet 20 via a telephone link, cable link, wireless link, Digital Subscriber Line or other types of communication links known in the art. Those of ordinary skill in the art will appreciate that the modem 50 includes the necessary circuitry for such a connection, and is also constructed for use with the TCP/IP protocol.

The user computer 30 also includes a processing unit 48, a display 46, and a memory 52. The memory 52 generally comprises a random access memory (RAM), a read-only memory (ROM) and a permanent mass storage device, such as a disk drive. The memory 52 stores the program code and data necessary for accessing healthcare information over the Internet 20. More specifically, the memory 50 stores portions of an anatomic user interface 58 formed in accordance with the present invention for accessing healthcare information. It will be appreciated that the portions of the anatomic user interface 58 stored in memory 50 of the user computer 30 may be downloaded from a Web server 36 such as that shown in FIG. 2 which stores the entire anatomic user interface 58 or, in the alternative, the portion of the anatomic user interface 58 stored in memory 50 of the user computer may be loaded into memory 50 of the user computer 30 from a computer-readable medium using a drive mechanism such as a floppy or CD-ROM drive.

The memory 52 also includes a Web browser 54, such as Netscape's NAVIGATOR or Microsoft's INTERNET EXPLORER browsers, and a JAVA virtual machine 60 for executing those portions of the anatomic user interface 58 written in the JAVA programming language. The Web browser 54 displays Web pages that are generated by the anatomic user interface 58 either locally on the user computer 30 or remotely on the application server 38.

As noted above in connection with FIG. 2, the Web servers 36 provide users who wish to access healthcare information with Web pages produced by the anatomic user interface 58. FIG. 3B depicts several of the key components of such a Web server 36. Those of ordinary skill in the art will appreciate that the Web server 36 includes many more components than those shown in FIG. 3B. However, it is not necessary that all of these generally conventional components be shown in order to disclose an actual embodiment for practicing the present invention. As shown in FIG. 3B, the Web server 36 is connected to the cluster server 34 and the application server 38 via a network interface 62. Those of ordinary skill in the art will appreciate that the network interface 62 includes the necessary circuitry for such connections, and is also constructed for use with TCP/IP protocol or the next generation protocols such as the Internet Inter-ORB Protocol (“IIOP”), the particular network configuration of the operating environment in which it is contained, and a particular type of coupling medium.

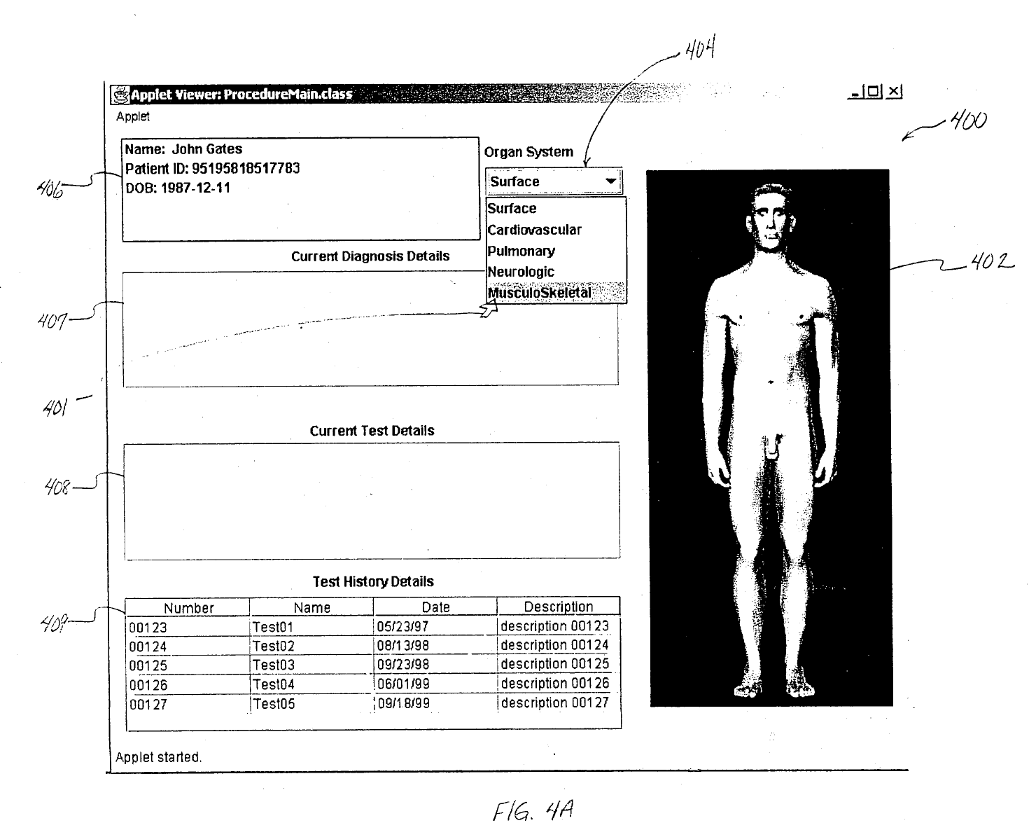

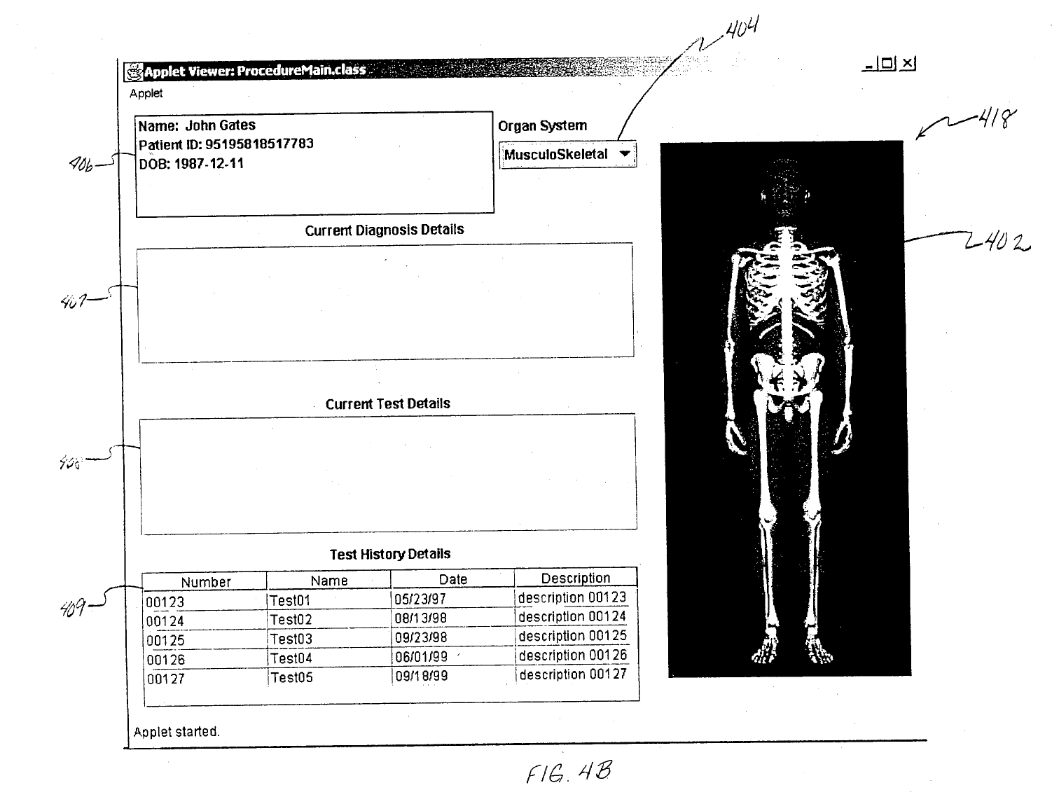

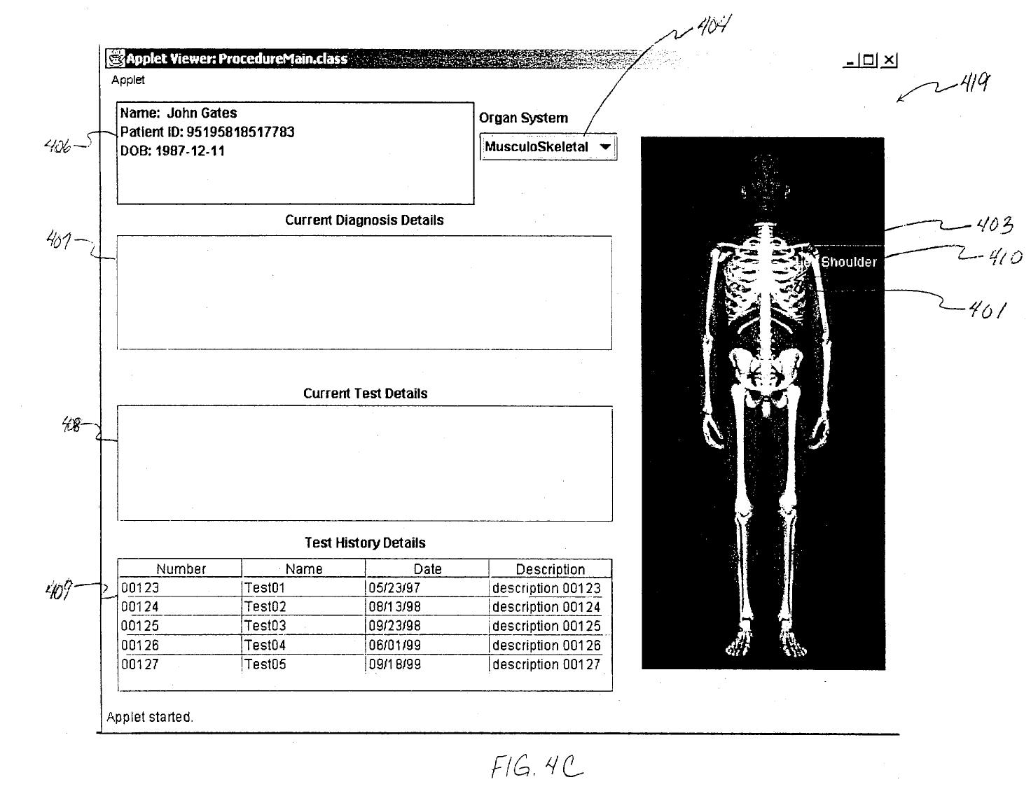

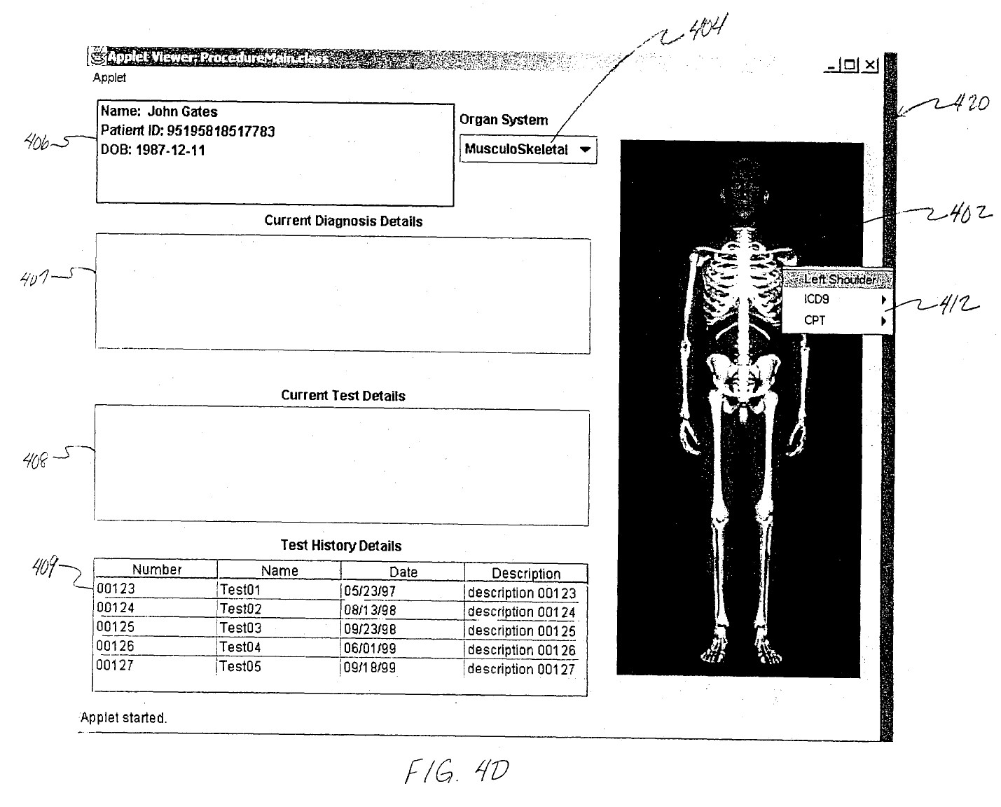

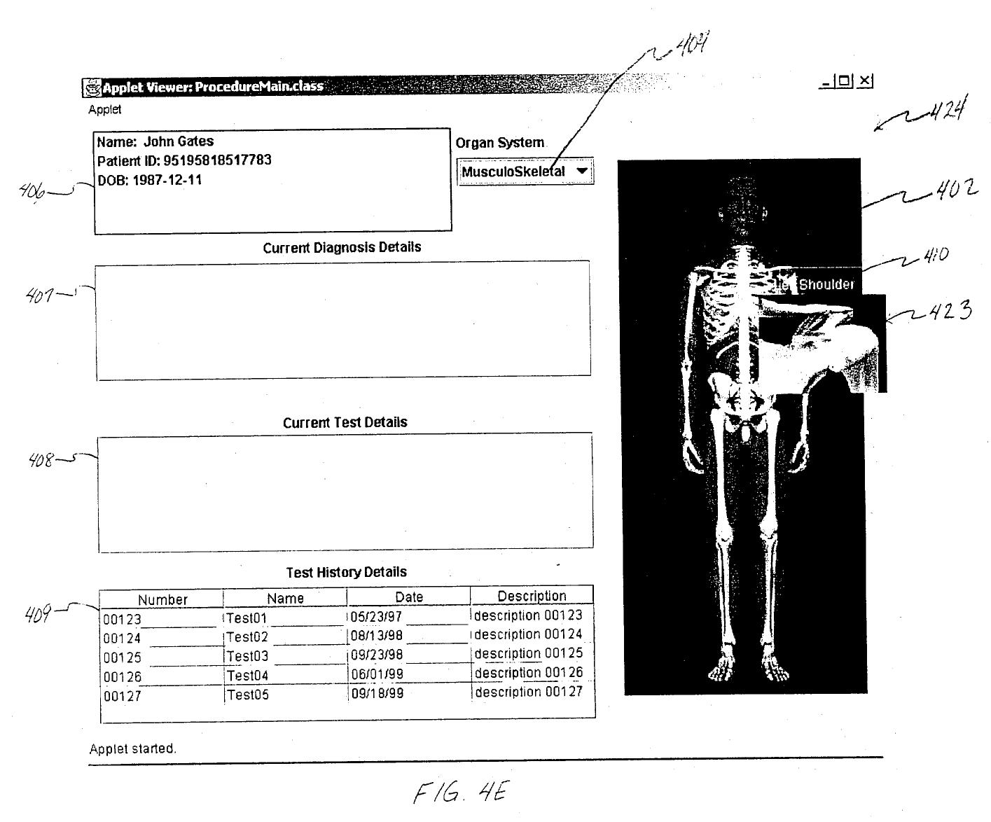

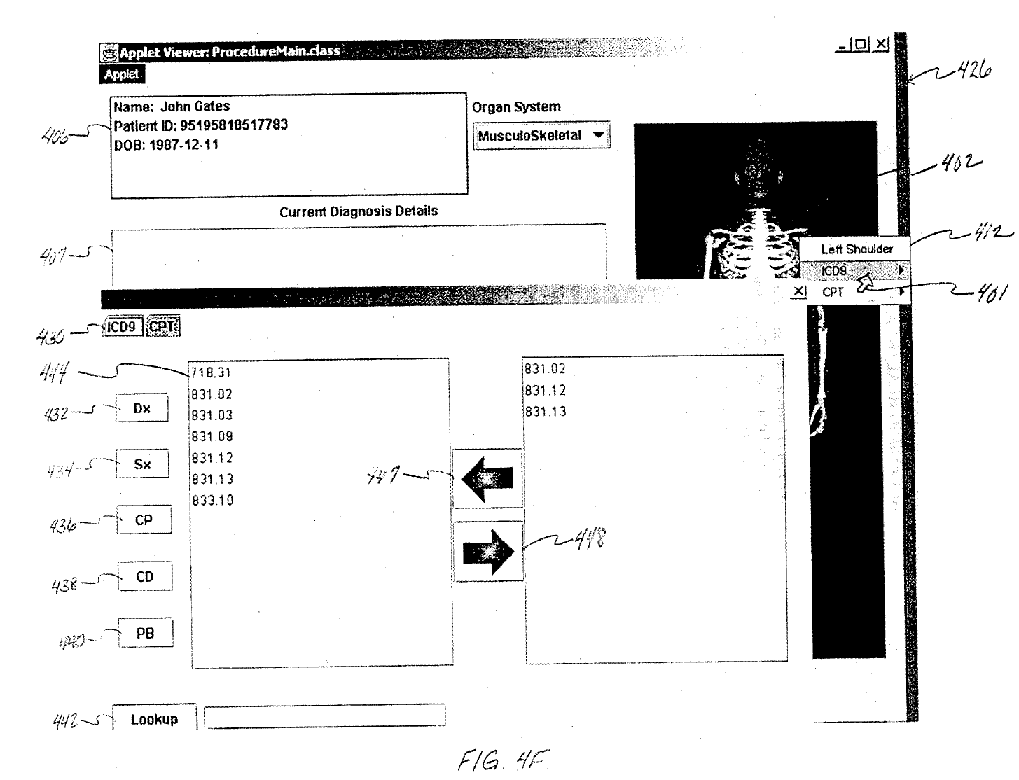

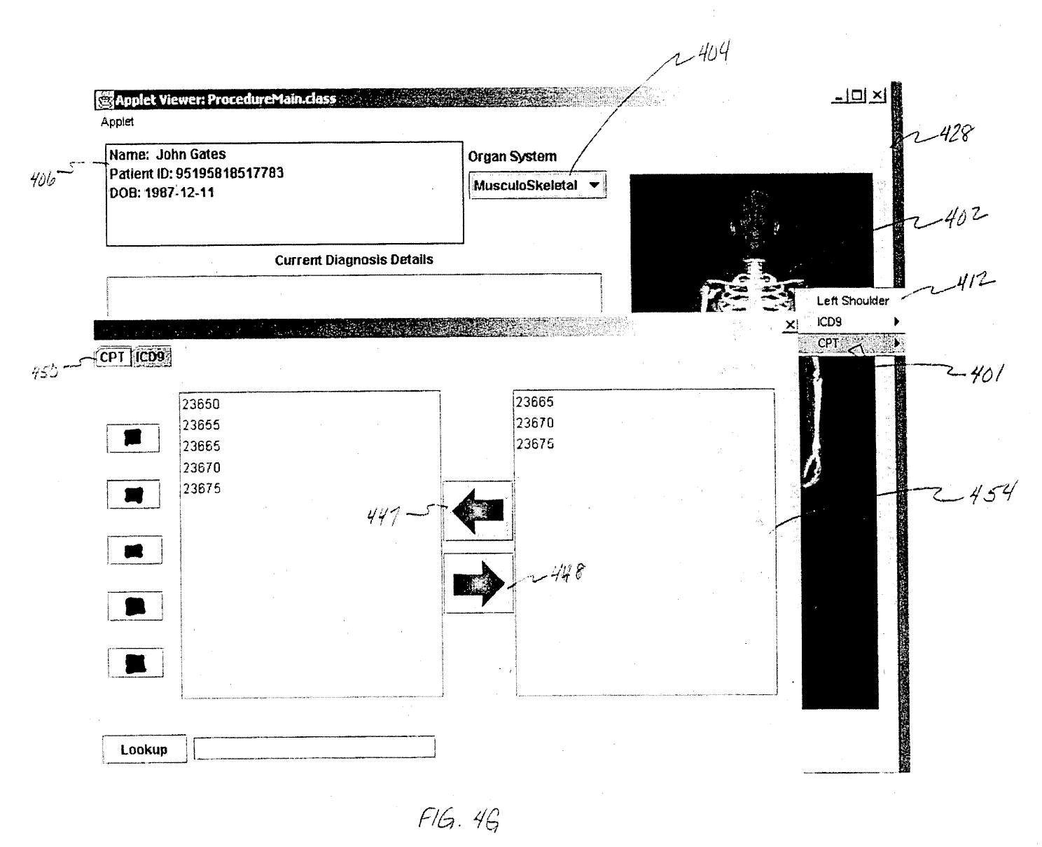

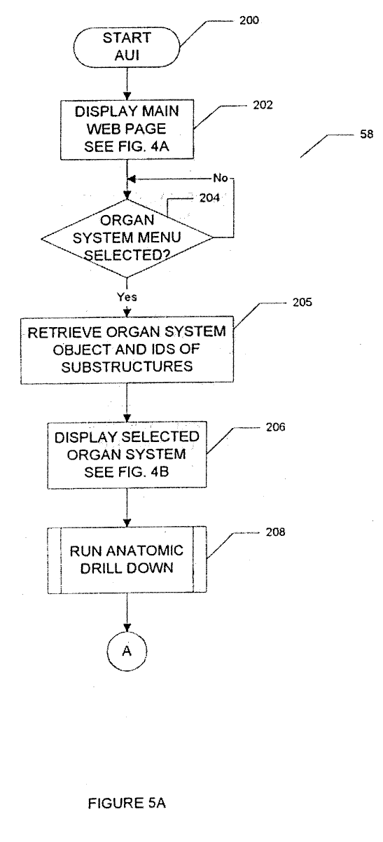

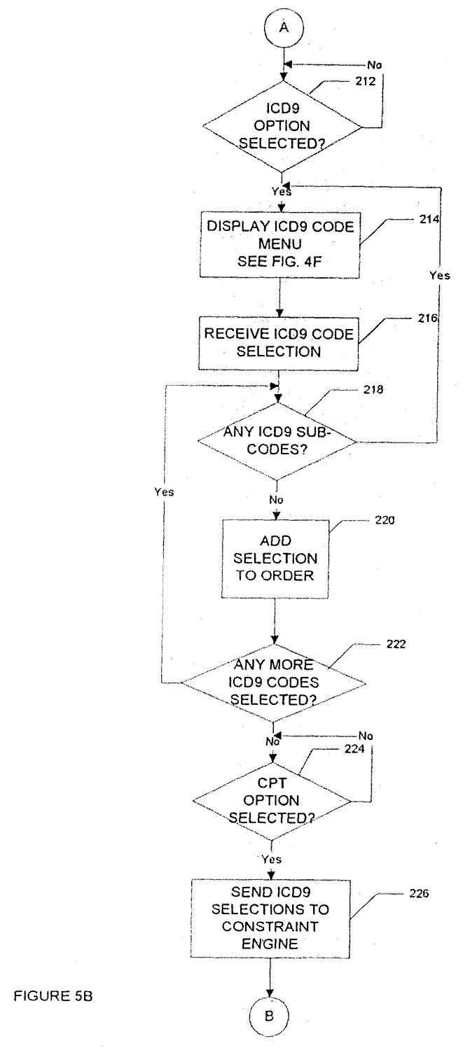

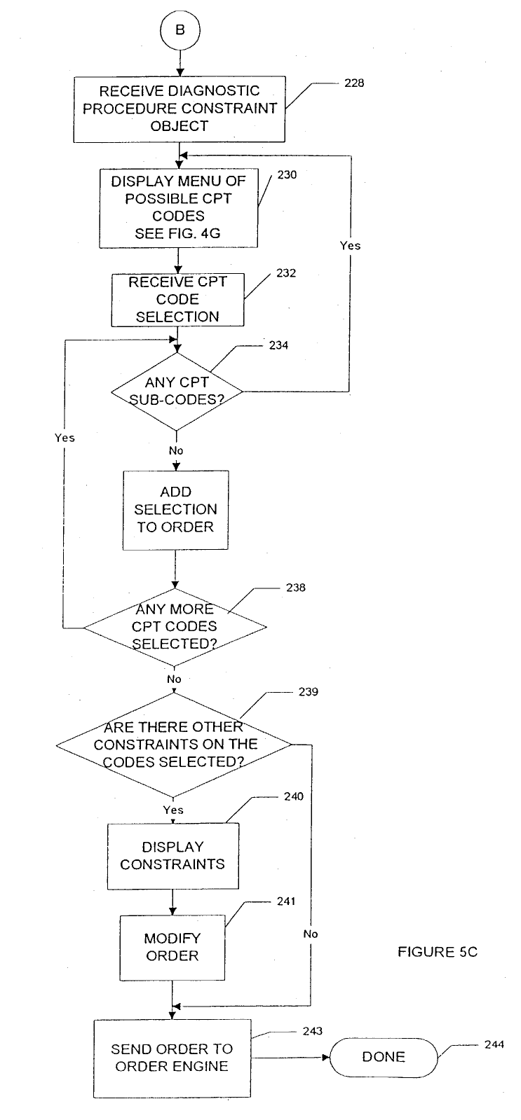

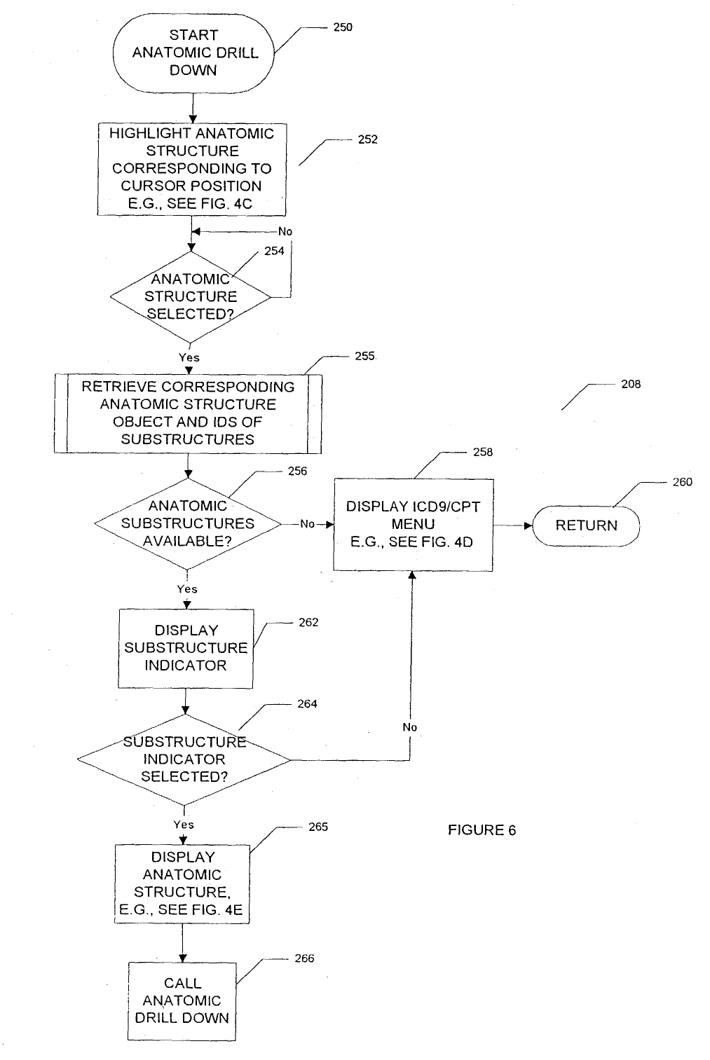

The Web server 36 also includes a processing unit 66, a display 64, and a mass memory 68. The mass memory 68 generally comprises RAM, ROM, and a permanent mass storage device, such as a hard disk drive, tape drive, optical drive, floppy disk drive, or combination thereof. The mass memory 68 also stores an operating system 70 for controlling the operation of the Web server 36. It will be appreciated that the operating system 70 may comprise a general-purpose server operating system as is known to those of ordinary skill in the art, such as UNIX, LINUX™, or Microsoft WINDOWS NT®. The mass memory 68 also stores the anatomic user interface 58 formed in accordance with the present invention for enabling a user to access healthcare information. In one actual embodiment of the present invention, the anatomic user interface 58 comprises computer executable constructions which, when executed by the Web server 36, generate the Web pages such as those shown in FIGS. 4A-4G, and perform the logic described below with respect to FIGS. 5A-5C, 6 and 7.

Finally, mass memory 68 stores an HTML/JAVA I/O handler application 71. The HTML/JAVA I/O handler application 71 receives requests for HTML Web pages, JAVA applets and JAVA server pages from the user computer 30 and, in response to those requests, calls the necessary portions of the anatomic user interface 58. The HTML/JAVA I/O handler application 71 also transmits output from the anatomic user interface 58 to the requesting user computer 30. This type of network communication is well known to those of ordinary skill in the art and thus, need not be discussed in further detail herein. It will further be appreciated that the software components stored in mass memory 68 may be loaded therein from a computer-readable medium using a drive mechanism such as a floppy or CD-ROM drive, or in the alternative, downloaded from another server connect to the Internet 20.

As noted above, a request to access healthcare information submitted by the user computer 30 using the anatomic user interface 58 is processed by the application server 38. FIG. 3C depicts several of the key components of the application server 38. Those of ordinary skill in the art will appreciate that the application sever 38 includes many more components than those shown in FIG. 3C. However, it is not necessary that all of these generally conventional components be shown in order to disclose an actual embodiment of practicing the present invention. As shown in FIG. 3C, the application server 38 includes a network interface 22 for connecting the application server to the other computer systems of the operating environment shown in FIG. 2. Those of ordinary skill in the art will appreciate that the network interface 72 includes the necessary circuitry for such a connection, and is also constructed for use with the TCP/IP protocol, the particular network configuration of the operating environment in which it is contained, and a particular type of coupling medium.

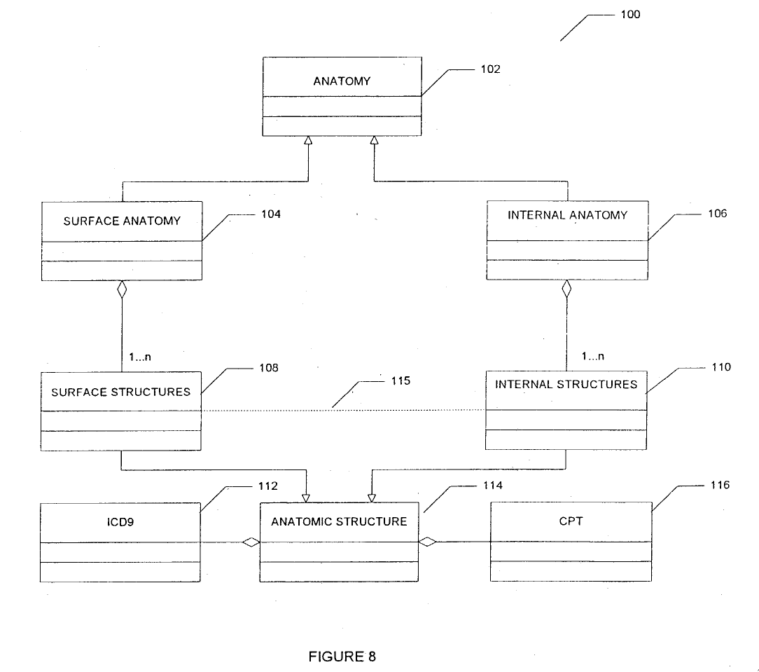

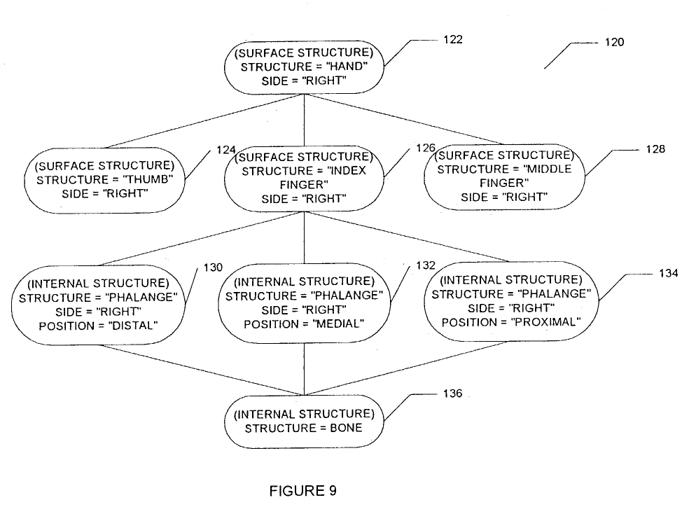

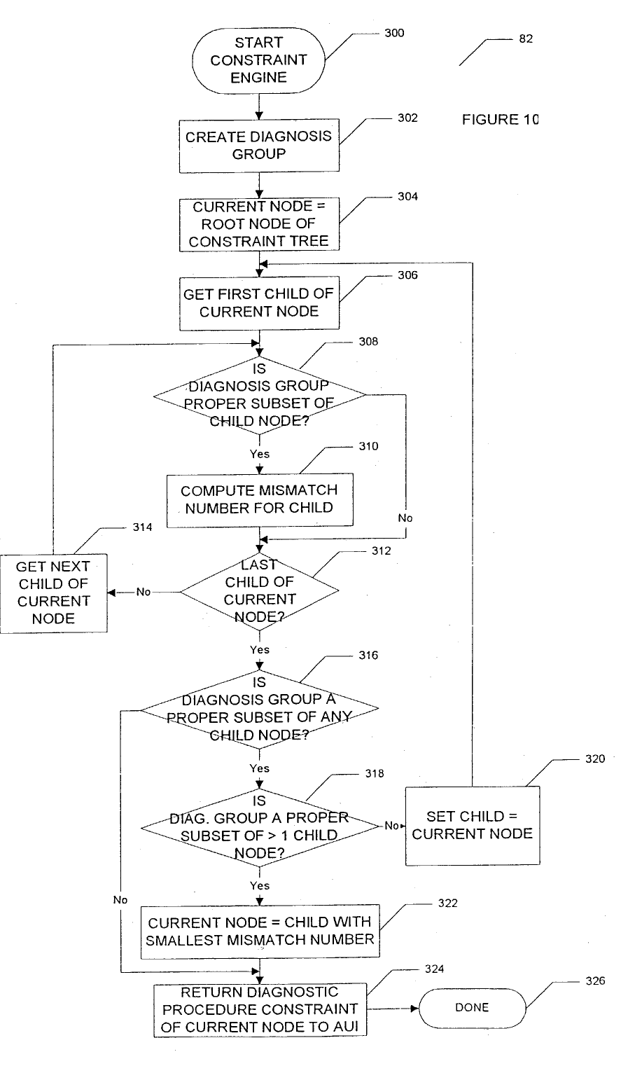

The application server 38 also includes a display 74, a processing unit 76, and a mass memory 78. The mass memory 78 generally comprises RAM, ROM, and a permanent mass storage device, such as a hard disk drive, tape drive, optical drive, floppy disk drive, or combination thereof. The mass memory 78 stores an operating system 80 (such as UNIX, LINUX™, or WINDOWS NT®) for controlling the operation of the application server 38. The mass memory 78 also stores the program code and data for providing the Web server 36 with the anatomic and patient information necessary for supporting the anatomic user interface 58 as well as the program code and data necessary for accessing the healthcare information desired by the user. More specifically, the mass memory 78 stores an anatomic data model 84 that represents the anatomic structures, which when considered as a whole, form the human anatomy. The anatomic data model 84 will be described in more detail below with reference to FIGS. 8 and 9. Mass memory 78 also stores a constraint engine 82 formed in accordance with the present invention for providing the anatomic user interface 58 with healthcare information associated with a particular anatomic structure selected by the user. For example, if the anatomic user interface 58 is being used to order healthcare services, the constrained engine 82 provides the ICD9 and CPT codes associated with a particular anatomic structure. More specifically, the constraint engine 82 comprises computer executable instructions which, when executed by the application server 38, perform the logic described below with respect to FIG. 10.

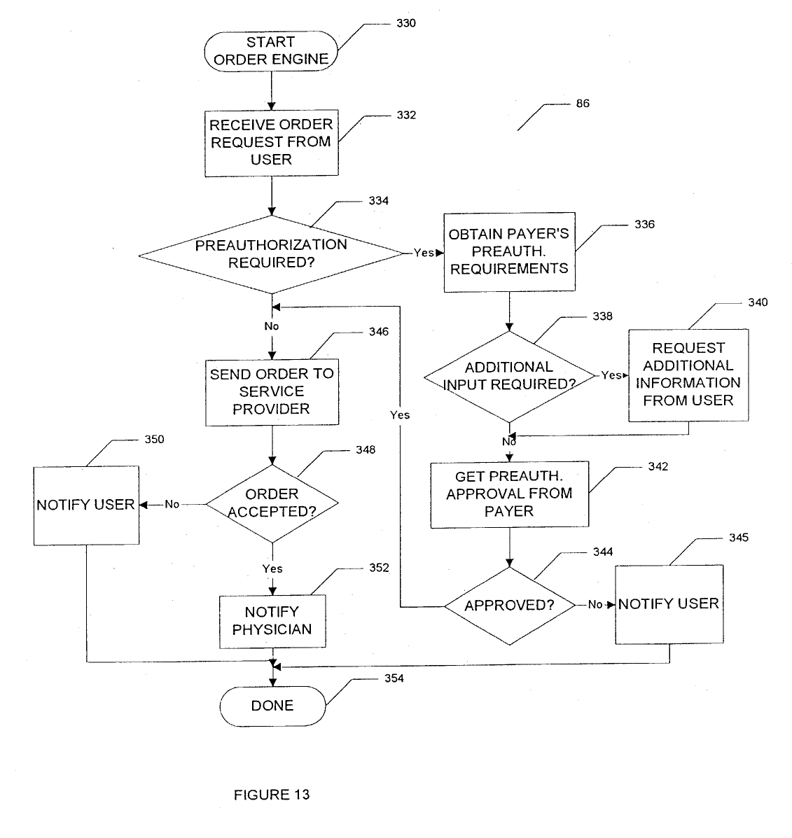

Finally, in the actual embodiment of the present invention that enables the user to order healthcare services, mass memory 78 also stores an order engine 86 for ordering healthcare services desired by the user. More specifically, the order engine 86 comprises computer executable instructions which, when executed by the application server 38, perform the logic described below with reference to FIG. 13. It will be appreciated that the software components stored in mass memory 78 may be loaded therein from a computer-readable medium using a drive mechanism such as a floppy or CD-ROM drive, or in the alternative, downloaded from another server connected to the Internet 20.

Turning now to the database server 40, it is responsible for maintaining the anatomic database 42 and patient database 97 in support of the anatomic user interface 58. FIG. 3D depicts several of the key components of a database server 40. Those of ordinary skill in the art will appreciate that the database server 40 includes many more components than those shown in FIG. 3D. However, it is not necessary that all of these generally conventional components be shown in order to disclose an actual embodiment for practicing the present invention. As shown in FIG. 3D, the database server 30 is connected to the other computer systems in the operating environment shown in FIG. 2 via a network interface 88. Those of ordinary skill in the art will appreciate that the network interface 88 includes the necessary circuitry for such a connection, and is constructed for use with the TCP/IP protocol, the particular network configuration of the operating environment in which it is contained, and a particular type of coupling medium.

The database server 40 also includes a processing unit 92, a display 90 and a mass memory 94. The mass memory 94 generally comprises RAM, ROM, and a permanent mass storage device, such as a hard disk drive, tape drive, optical drive, floppy disk drive, or combination thereof. The mass memory 94 stores an operating system 96 for controlling the operation of the application server 40, as well as the anatomic database 42 and the patient database 97. It will be appreciated that the software components stored in mass memory 94 may be loaded therein from a computer-readable medium using a drive mechanism such as a floppy or CD-ROM drive, or in the alternative, downloaded from another server connected to the Internet 20.

The anatomic database 42 contains anatomic data used to support the anatomic data model 84 stored in mass memory 78 of the application server 38. It will be appreciated that the human anatomy is comprised of a plurality of anatomic structures and substructures, e.g., one anatomic structure of the human anatomy is the right hand, the right hand contains anatomic substructures comprising a right thumb, right index finger, etc. The right thumb contains further anatomic substructures, such as the distal, medial and proximal phalanges. The anatomic database 42 contains the data describing the anatomic structures and substructures referred to collectively as “anatomic structures” that make up the human anatomy. In addition, each anatomic structure and substructure contained in the anatomic database 42 has associated with it various healthcare information such as diagnoses, tests, treatments, drugs, medical vocabularies, etc.

In one actual embodiment of the present invention in which healthcare services are being ordered, the anatomic database 42 stores the set of possible medical diagnoses that are valid for each anatomic structure. The diagnoses are identified by ICD9 codes. As those of ordinary skill in the art will appreciate, the direct association of the ICD-9 codes with the underlying anatomic structures of the human anatomy provides a basis for validating diagnoses entered by the user when ordering a healthcare service and ensuring that the order is correctly coded. Each anatomic structure contained in the anatomic database 42 also has associated with it all of the healthcare services that are valid for it. In one actual embodiment of the present invention, the healthcare services are identified by CPT codes. As will be described in more detail below, when a user selects a certain diagnosis for a desired anatomic structure, the user will then be provided with the CPT codes for the healthcare services that are available and appropriate for the selected diagnosis(es).

It will be appreciated by those of ordinary skill in the art that in other embodiments of the present invention, different, additional and/or updated industry accepted codes may be used to describe healthcare information, e.g., the Systematized Nomenclature of Medicine (“SNOMED”) for clinical information, Logical Observation Identifiers, Names and Codes (LOINC™) for identifying laboratory and clinical observations, the Physicians' Desk Reference for medication, etc., without departing from the scope of the present invention.

The patient database 97, on the other hand, contains specific information for each patient for whom healthcare services are being ordered. For example, the patient database 97 contains demographic information for each patient such as the patient's name, address, patient identification number (e.g., social security number) payment information (e.g., name of the payer, billing address, etc.), attending physician, pharmacist, date of birth, etc. In addition, the patient database 97 includes patient anatomic information, i.e., anatomic information specific to the particular patient. While the anatomic data stored in anatomic database 42 comprises standard reference information reflecting current knowledge about the anatomy of normal humans, the patient anatomic data stored in patient database 97 includes information reflecting differences between a particular patient's anatomy and a normal human anatomy. For example, the patient may have had his or her appendix removed or may have an extra finger. Accordingly, the patient database 97 will identify the anatomic structure the patient does or does not have. Since the patient database 97 focuses only on the extensions between the patient's data and the standard reference data stored in the anatomic database 42, the patient database 97 will contain only those anatomic structures that are changed from the reference. A complete description of the patient is obtained by merging the patient anatomic data with the standard reference anatomic data during retrieval via the anatomic data model 84. This is accomplished by linking the anatomic data model 84 to the patient database 97 as well as the anatomic database 42. Thus, as described in more detail below, when an anatomic model 402 for the patient is displayed to the user by the anatomic user interface 58, the model will be displayed with or without those particular anatomic structures identified in the patient database 97.

Those of ordinary skill in the art will appreciate that as healthcare information is accessed for patients and patient information is supplied by the user, a record containing that patient's relevant demographic and is added to the patient database 97. As for any patient-specific anatomic information, it will be appreciated that such information is typically added to the patient database 97 via a separate or prior implementation of the anatomic user interface 58. For example, if prior healthcare services were ordered using the anatomic user interface 58, which required an appendectomy, the patient's record in the patient database 97 would include an anatomic structure object identifying that the appendix had been removed. In another embodiment, the user could implement the anatomic user interface 58 to record a patient's medical history, thus using the anatomic drill down to select those anatomic structures and anatomically related information that are to be added to the patient database 97. Accordingly, it will be appreciated that every use of the anatomic user interface 58 for a particular patient may add to and build upon the medical history of the patient. This medical history will then automatically be reflected in the anatomic model 402 of the patient presented to the user and shape the context in which the user retrieves healthcare information, i.e., automatically focus information to the clinical question and automatically eliminate from the user's consideration irrelevant healthcare information.

An Intuitive, Web-Based Interface for Accessing Healthcare Information

User computers, such as computer 30, are normally provided with a Web browser 54 to provide users with a graphical user interface to the Internet 20 and the WWW. In accordance with an actual embodiment for practicing the present invention, an ordering practitioner or other remote user may connect to a Web server 36 via the Internet 20 using the Web browser 54 and retrieve various Web pages generated by the anatomic user interface 58 resident upon the Web server 36. The user may then access healthcare information for a particular patient via the retrieved Web pages. For example, a user of computer 30 and Web browser 54 may retrieve a home page for the anatomic user interface 58 from the Web server 36 and login to the anatomic user interface 58 using a previously assigned user ID and password. Once logged in, the user submits information identifying the patient for whom the healthcare information is being accessed via another Web page displayed via the browser 54. As those ordinary skill in the art will appreciate, if the patient database 97 maintained by the database server 40 does not already include a record for the patient, the user will have the option of adding a record for that patient to the patient database 97 including the patient's name, identification number, date of birth, payer information, service provider, desire for evidence based medicine, etc. Since such login and setup Web pages are already fairly standard and well known in the art, it is unnecessary to describe them any further herein.

Once the user has provided the necessary information for identifying the patient, Web browser 54 of the user computer 30 displays a Web page 400 as shown in FIG. 4A from which the user will ultimately retrieve the healthcare information desired for the patient. Web page 400 includes a high-level model 402 of the human anatomy. As will be described in more detail below, the ordering practitioner will use the anatomic model 402 to drill down to a particular anatomic structure for which healthcare information is to be accessed. More specifically, the user begins his or her drill down to a particular anatomic structure by first selecting the overall organ system of the patient to be treated from an organ system menu 404. As those skilled in the medical arts will appreciate, the structures of the human anatomy to be treated and the healthcare information that may be applicable to such structures will vary depending on the organ system to be treated. As shown in FIG. 4A, the overall organ systems that may be treated may include the surface (skin) system, the cardiovascular system, the pulmonary system, the neurologic system and the musculo/skeletal system. However, different or additional organ systems could be included without departing from the scope of the present invention, e.g., gynecology, endocrine, hematologic/immulogic, breast, gastro/intestinal, genito/urinary, head/neck, hepato/pancreatic, psychiatric, etc. Once the organ system is selected by the user, the anatomic user interface 58 applies the organ system to the anatomic model 402, and the drill-down continues as the user selects various anatomic substructures of the organ system for which he or she wishes to access information.

It will be appreciated that even though the organ system is a high level anatomic structure, the organ system selection efficiently reduces the possible healthcare information that may be available to a specific anatomic structure within a specific context, wherein the context is defined by the selected organ system, the patient's medical history and the type of healthcare information being accessed. For example, the healthcare information for the musculo/skeletal system is different than the information for the hepato/pancreatic system, which is different than the gastro-intestinal system, and so on. Further, the healthcare diagnosis available for the gastro-intestinal system of a patient who has had an appendectomy and right lower quadrant pain will be different than the healthcare diagnosis for a patient who has right lower quadrant pain and an appendix. By providing an accurate anatomic model 402 for healthcare information, the anatomic user interface 58 enables the user to drill down to desired healthcare information or actions, such as ordering medical procedures, prescribing drugs, etc., using a familiar reference point common to all healthcare processes. Thus, by looking at the anatomic model 402, the user intuitively knows where to go to begin extracting the healthcare information he or she needs, i.e., to the particular anatomic structure of interest. Since the anatomic structures of the model are associated with a multi-dimensional data set of healthcare information, the remaining components of the present invention, such as the anatomic data model 84, the constraint engine 82, etc., use the anatomic structures to eliminate irrelevant healthcare information and provide the user with only a subset of context relevant, more easily navigable information to which the user may have access and upon which the user may act.

Ordering Healthcare Services

As noted above in accordance with one actual embodiment of the present invention, the healthcare information desired by the user may be healthcare diagnosis and service information. Accordingly, the anatomic user interface 58 may be used not only to access the healthcare information, but order the healthcare services as well. In the actual embodiment of the present invention depicted in FIGS. 4A-4G, the healthcare services desired by the user are radiology exam services. However, as those of ordinary skill in the art will appreciate, in other actual embodiments of the present invention, users may order any type of healthcare service. For example, the user may implement the anatomic user interface 58 to obtain order pharmaceuticals, medical supplies, neurological exams, etc. However, radiology services are used herein to describe an illustrative embodiment of the present invention.

The logic implemented by the anatomic user interface 58 to enable a user to drill down from the high-level anatomic model 402 to a particular surface or internal anatomic structure to be treated, and ultimately to order healthcare services for the anatomic structure, is shown in more detail FIGS. 5A-5C. The logic begins in FIG. 5A in a block 200 and proceeds to a block 202 where the anatomic user interface 58 provides the Web browser 54 of the user computer 30 a main Web page 400 for ordering healthcare services as shown in FIG. 4A. Web page 400 includes a patient identification field 406 that displays the name, patient identification number and date of birth of the patient for whom the healthcare services are to be ordered. Additional fields are then displayed that identify the type(s) of healthcare information the user is accessing. For example, in the healthcare service order context, a current diagnoses details 407 is filled with information describing the healthcare diagnosis associated with a particular anatomic structure the user has selected, namely, a general description of each medical diagnosis and the ICD9 code for each diagnosis. A current test details field 408 is also displayed which is filled with information describing the healthcare services to be ordered, namely, a general name of each healthcare service, the industry accepted title for the healthcare service, and the CPT code for the health service. Finally, test history details field 409 is also included in the healthcare service order context which includes information identifying healthcare services previously ordered for the patient.

Next, in a decision block 204, the anatomic user interface 58 determines if the user has selected an organ system from the organ system menu 404. If not, decision block 204 is merely repeated until the user makes such a selection and the logic proceeds to block 205 in which the anatomic user interface 58 retrieves an organ system object from the anatomic data model 84 stored on the application server 38. As will be described in more detail below in connection with FIG. 8, the organ system object is actually an instantiation of an anatomic structure object 114 which includes the data and methods necessary for displaying the selected organ system selected by the user. The organ system object is retrieved from the anatomic data model 84 along with an identifier for each first level, anatomic substructure of the organ system.

As noted above, each anatomic structure of the human anatomy (including the organ system) may be divided into further first level substructures and each first level anatomic substructure may be divided into further second level anatomic substructures, and so on to an n^{th} level of substructures. For example, the musculo/skeletal organ system can be divided into the substructures of the hand, forearm, upper arm, shoulder, etc. Accordingly, when an anatomic structure object 114 such as the organ system object is retrieved from the anatomic data model 84, it is accompanied by an internal identifier for each such first level substructure. The internal identifier includes the substructure's location within the anatomic model and the visual cues for the user including a written descriptor for the anatomic structure and a right or left side label. As will be described in more detail below, the internal identifiers are used to help the user drill down to the next level of anatomic detail.

Once the organ system object is retrieved, the anatomic user interface 58 provides, and the Web browser 54 displays, a Web page 418 as shown in FIG. 4B with the organ system selected by the user applied to the anatomic model 402. Hence, if the user selects the musculo/skeletal organ system from the organ system menu 404 as shown in FIG. 4A, the anatomic model 402 will be overlaid with the musculo/skeletal organ system as shown in FIG. 4B. Since information identifying the patient, including the patient's gender and age, has already been supplied by the user, any gender or age specific differences in the anatomic model 402 and selected organ system are shown in the model. In the illustrative example depicted in FIGS. 4A-4G, the patient is male and thus, the anatomic model 402 displayed in the Web pages produced by the anatomic user interface 58 is for a male patient. Further, it will be appreciated that if the patient's record as stored in the patient database 97 indicates that an anatomic substructure of the selected organ system is missing or an extra structure is present, the anatomic structure will be removed from or added to the anatomic model 402 accordingly.

Once the selected organ system is applied to the anatomic model 402 and displayed to the user in block 206, an anatomic drill-down subroutine is initiated in block 208. The anatomic drill-down subroutine is shown in more detail in FIG. 6. The subroutine begins in a block 250 and proceeds to a block 252 where the first level anatomic structure corresponding to the position of a graphics cursor 401 being manipulated by the user is highlighted. It will be appreciated that as the user manipulates the graphics cursor 401 above the anatomic model 402 using a mouse or similar user input device, the first level anatomic substructures are highlighted beneath the graphics cursor 401 along with their identifier as retrieved from the anatomic data model 100. For example, as shown in FIG. 4C, if the user manipulates the graphics cursor 401 above the anatomic structure of the left shoulder 410, the anatomic structure is highlighted, the written descriptor “left shoulder” appears in close proximity to the anatomic structure, and the left label appears along side the anatomic model 402. Thus, by laying a coordinate grid over the anatomic model 402 and assigning the location of each anatomic substructure to the grid, the position of the graphics cursor 401 within the coordinate grid can easily be used to identify and highlight the underlying anatomic structure.

It will be appreciated from the foregoing discussion that the underlying anatomic structure to be highlighted depends on the organ system selected by the user, again demonstrating how selection of the organ system efficiently narrows the possible healthcare information to the area of interest. For example, in the musculo/skeletal model, a graphical cursor 401 over the right upper arm would indicate the right humerus. In the vascular model, a cursor over the upper arm would indicate the arterial or venous substructures. The ICD9 and CPT codes valid for the right humerus are much different than the ICD9 and CPT codes valid for the arteries and veins of the right upper arm. Thus, the same graphic cursor position produces different outputs and different related healthcare information dependent on which organ system or anatomic substructure is selected and the purpose of the process, i.e., information retrieval on a patient or order of a healthcare service. For example, selection of the right eye can produce a medical history related to the right eye of a specific patient or could be used to order tests, procedures or medication for the right eye for that patient depending on the context or purpose of the selection.

Once the anatomic structure corresponding to the position of the graphics cursor 401 is displayed or “highlighted,” the user may select the anatomic structure or move on to another anatomic structure. If the highlighted anatomic structure is not selected, the anatomic drill down subroutine will continue to display further anatomic structures corresponding to the position of the graphics cursor 401 as the user passes the graphics cursor above the anatomic model 102 as described above. However, once a highlighted anatomic structure is selected by the user, the logic proceeds from decision block 254 to a block 255 where the anatomic structure object 114 for the selected anatomic structure is retrieved from the anatomic data model 84 along with the identifiers for any of its substructures.

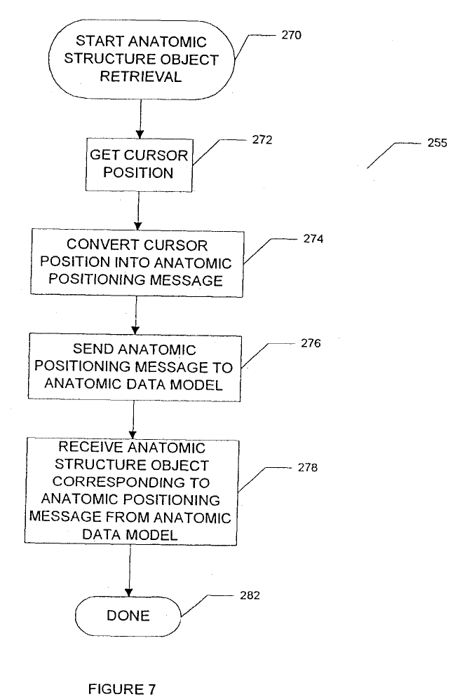

A subroutine for retrieving the anatomic structure object 114 is shown in more detail in FIG. 7. The logic begins in FIG. 7 in a block 270 and proceeds to a block 272 where the subroutine obtains the position of the graphics cursor 401 on the coordinate grid. Next, in a block 274, the position of the graphics cursor 401 is converted into an anatomic positioning message by formatting the location identifier for the underlying anatomic structure into a database query. The anatomic positioning message is then sent to the anatomic data model 84 maintained by the application server 38, which in turn queries the anatomic database 42 and the patient database 97 and retrieves an instantiation of the corresponding anatomic structure object 42. It will be appreciated that if the patient database 97 contains different data for the same anatomic structure being selected, then the patient-specific data is retrieved by the anatomic data model 84. Accordingly the patient-specific anatomic structure is displayed by the anatomic user interface 58 instead of the standard reference anatomic structure.

After the anatomic structure retrieval subroutine receives the appropriate anatomic structure from the anatomic data model 84, the subroutine then ends in a block 282.

The anatomic data model 84 is an organizational data model for medical information that is based on the human anatomy. The anatomic data model consists of three components: (1) an anatomic object model 100; (2) the anatomic database 42; and (3) the patient database 97. The anatomic object model 100 is shown in more detail in FIG. 8. The anatomic object model 100 reflects the structural components of the human anatomy by presenting two views of the human anatomy: surface anatomy and internal anatomy. Surface anatomy includes those anatomic structures that are essentially visible to the human eye, e.g., the hand, face, shoulder, skin, etc., while internal anatomy are those structures below the skin, e.g., bones, blood vessels, internal organs, etc. The anatomic object model 100 is organized into classes of anatomic objects according to whether the anatomic object describes surface anatomy or internal anatomy. In one actual embodiment of the present invention, an object-oriented programming paradigm is used to represent the classes of anatomic objects into which the human anatomy is classified according to the organ system selection made by the user.

Using an object-oriented programming paradigm, each of the human anatomy structure is associated with an object, i.e., a variable comprising data and methods that define the behavior of that anatomic structure. Methods are procedures or code that operate upon and isolate the data, making the object inter-operable with other objects regardless of the data contained by those objects. The objects in an object-oriented programming paradigm can be organized into classes in a hierarchical fashion or aggregated into related groups of objects. A class defines a certain category or grouping of methods and data for each object in the class. Each class of objects may be divided into further subclasses of objects, each subclass may be divided into further “sub-subclasses,” and so on. The objects of each subclass inherit the methods and data of its parent class (or subclass), plus they each include additional methods and data that are unique to its subclass. Any object of an object-oriented programming paradigm may also be related to a group or aggregation of objects each having the same methods and procedures, but different data to differentiate them. Although related, the aggregated objects do not “inherit” data or methods from the object to which they are related.

FIG. 8 shows an anatomic object model 100 employed in one actual embodiment of the present invention and stored in memory 78 of the application server 38. The anatomic object model 100 begins with a generic anatomy object 102. A surface anatomy object 104 and an internal anatomy object 106 are each shown as a subclass beneath the generic anatomy object 102. Thus, the surface anatomy object 104 and internal anatomy object 106 each inherit the generic data and methods of anatomy object 102, plus each includes additional data and methods that are unique to its subclass. Specifically, surface anatomy object 104 contains the data and methods necessary for identifying the surface anatomy associated with the anatomic model 102, while the internal anatomy object 106 includes the data and methods necessary for identifying the internal anatomy of the anatomic model 102.

Anatomic structures, whether internal or surface, may be made up of smaller substructures. For example, the surface anatomic structure of the spine may contain three smaller surface substructures, e.g., cervical, thoracic, and lumbar. Accordingly, the surface anatomy object 104 and the internal anatomy object 106 are related to an aggregation of further surface or internal structure objects. More specifically, the surface anatomy object 104 is related to an aggregation of specific surface structure objects 108, while the internal anatomy object 106 is related to an aggregation of specific internal structure objects 110. Those of ordinary skill in the medical arts will recognize that a surface structure of the human anatomy may have underlying internal structure associated with a particular organ system. Thus, when such a relationship between a surface structure and an internal structure occurs, the surface structure object 108 and internal structure object 110 include a topographical link 115 to one another.

As will be described in more detail below, the topographical link 115 may come into play as the user drills down to the specific anatomic structure for which healthcare information is to be accessed or healthcare services are to be ordered. More specifically, if the user begins his or her drill down at a surface structure level, the user may eventually reach the most granular level of surface structure made available by the anatomic user interface 58. Consequently, the next level of anatomic structure made available by the anatomic user interface 58 may be the corresponding internal anatomic structures of the surface structure. For example, if using the anatomic user interface 58, the user drills down to the index finger of the right hand, the next level of available anatomic substructures may be the distal, medial and proximal phalanges of the right index finger. Accordingly, a topographical link 115 will exist in the anatomic object model 100 between the surface structure object 108 for the right index finger and the internal structure objects 110 for each of the distal, medial and proximal phalanges.

The relationship 120 between internal an surface anatomy captured by the anatomic object model 100 is shown in more detail in FIG. 9, again using the right hand as an example. As depicted, any surface structure, such as the right hand 122 may have further surface substructures, such as the thumb 124, index finger 126, middle finger 128, etc. Any of those surface substructures may have its own further substructures and so on. In addition, any surface structure or substructure may have its own internal structures, e.g., in the musculo/skeletal organ system, the distal phalange 130, medial phalange 132 and proximal phalange 134 of the right index finger 126. Similarly, any of those internal structures may have its own internal substructures such as the bone 136. Consequently, if the user so desires, he or she can drill down to the most granular level of internal anatomy from any higher level of related surface or internal anatomy.

Returning to FIG. 8, each surface structure object 108 and internal structure object 110 is related to an anatomic structure object 114 which includes the data and methods necessary for displaying a particular surface structure or internal structure to the user. In particular, the anatomic structure object 114 includes an image of the anatomic structure, a written descriptor of the structure, and visual cues indicating right or left side, proximal/distal, cephaled/caudal, anterior/posterior, etc. In addition, each anatomic structure object 114 has associated with it an ICD9 object 112 and a CPT object 116 that include the data and methods necessary for identifying all of the ICD9 codes and CPT codes, respectively, that are valid for the anatomic structure object 114. Consequently, when the anatomic structure corresponding to the graphics cursor 401 is returned by the anatomic data model 84 to the anatomic user interface 58 (i.e., as an instantiation of the anatomic structure object 114), it is returned along with all of the ICD9 codes and CPT codes that are valid for it.

Returning to FIG. 6, once the anatomic structure object 114 for the selected anatomic structure is retrieved in a block 255, the anatomic drill down subroutine determines in a decision block 256 whether additional substructures to the highlighted anatomic structure are available. As noted above, certain anatomic structures may themselves be made up of smaller substructures. However, if further anatomic substructures are not available, then the finest layer of substructure granularity has been reached and the logic will merely proceed from decision block 256 to a block 258. In block 258 the selected anatomic structure is displayed along with a menu 412 from which the user may select either ICD9 codes or CPT codes. An example of such a menu 412 is shown in FIG. 4D with reference to Web page 420 in which the right shoulder anatomic structure 410 has been selected by the user. The anatomic drill down subroutine then ends in a block 260.

However, if the highlighted anatomic structure contains further substructures within the organ system selected by the user, the anatomic drill down subroutine proceeds from decision block 256 to a block 262 where a substructure indicator 403 is displayed next to the highlighted anatomic structure as shown in FIG. 4C. For example, a magnifying glass icon may be displayed to the user to indicate that further substructures are available. Next, in a decision block 264, the anatomic drill down subroutine determines if the user has selected the substructure indicator. If not, the originally highlighted anatomic structure is displayed along with the ICD9/CPT menu 412 as shown in FIG. 4D in block 258, and the subroutine ends in block 260.

However, if the user has selected the substructure indicator 403, the highlighted and selected anatomic structure is displayed in more detail in a block 265. More specifically, the full image of the selected anatomic structure as contained in the retrieved anatomic structure object 114 is displayed. The user may then select any desired substructures from the more detailed image. Accordingly, a recursive call to the anatomic drill down subroutine is made in a block 266. As a result, the user is again allowed to pass the graphics cursor 401 over the anatomic structure, highlight further substructures and select a particular substructure. As those of ordinary skill in the art will appreciate, by recursively calling the anatomic drill down subroutine, the user is allowed to drill down to a particular anatomic structure for which the user wishes to retrieve medical information, or in this case order healthcare services.

For example, as shown in FIG. 4E, if the user selects the substructure indicator 403 for the left shoulder anatomic structure, a Web page 424 is generated and displayed which exposes a detailed image 423 of the left shoulder, including the anatomic structures comprising the humerus, scapula and clavicle. Accordingly, if the user desires to drill down to these further anatomic substructures, another recursive call to the anatomic drill down subroutine from the left humerus would expose a more detailed image of the left humerus, including its anatomic substructures such as the humeral head, biceps groove, etc. It will be appreciated also, that the first time an anatomic structure having specific spatial relationship cues such as a right or left side, proximal or distal distinction, etc. is selected by the user, the spatial relationship cue will carry automatically to the selected anatomic structure's substructures and automatically carry to the eventual health services order. Consequently, there is no need for the user to repeatedly provide a right/left, proximal/distal, etc. label.

Returning to FIG. 5A, once the user drills down to and selects the anatomic structure desired using the anatomic drill down subroutine in block 208, the anatomic user interface 58 enables the user to drill down to and select the CPT codes identifying the healthcare services the user wishes to order through a series of menus. Accordingly, in a decision block 212 of FIG. 5B the anatomic user interface 58 determines whether the user has selected the ICD9 code option or the CPT code option from the menu 412. If not, the logic merely repeats decision block 212 until the user selects the ICD9 code option. In the actual embodiment of the present invention described herein, the user is forced to select the ICD9 code option from the menu 412 before selecting the CPT code option. Those of ordinary skill in the medical arts will recognize that a diagnosis or symptom is normally made before the appropriate healthcare services for that diagnosis are selected. Thus, the user is essentially required to select the ICD9 codes for the previously determined diagnoses before selecting any CPT codes. However, in other embodiments of the actual invention, it may be more pragmatic to select the healthcare services that may be available for the patient and then select those diagnoses that are valid for those healthcare services. Thus, in these embodiments the user may be allowed to select the CPT code option from the menu first.

Returning to decision block 212, once the ICD9 code option is selected, a Web page 426 as shown in FIG. 4F is displayed via the browser 54 on the user computer 30. Web page 426 includes an ICD9 tab 430 from which the user will select ICD9 codes. More specifically, the ICD9 tab 430 includes an ICD9 code menu field 444 listing all of the possible ICD9 codes that are valid for the selected anatomic structure. As noted above, this list of all possible ICD9 codes is returned to the anatomic user interface 58 along with the anatomic structure by the anatomic data model 84 during the anatomic structure retrieval subroutine. However, many ICD9 codes include various, more specific subcodes. Thus, in order to select an appropriate ICD9 code, the user must navigate a series of menus organized in accordance with the International Classification of Diseases, 9^{th} Edition, which classifies medical diagnoses into broader categories having more specific subcategories, such as diagnosis, symptom, complaint, condition or problem. Hence, the user must drill down to a specific ICD9 code through these menus. Accordingly, the user may select a diagnosis button 432, a symptom button 434, a complaint button 436, a condition button 438, or a problem button 440 from the ICD9 tab 430 to obtain the subset of originally displayed ICD9 codes that fall into the diagnosis, symptom, complaint, condition and problem categories, respectively. For example, if the user selects the diagnosis button 432, only those ICD9 codes of the original group that fall into that category are displayed in the ICD9 code menu field 444. However, any of these codes may also have further subcodes. Therefore, when the user selects an ICD9 code from the menu field 444, the anatomic user interface 58 determines in a decision block 218 if the selected ICD9 code has any further subcodes associated with it. If so, the anatomic subroutine 58 returns to block 214 and a menu of the ICD9 subcodes is displayed in the ICD9 code menu field 444.

The user may select ICD9 codes from the ICD9 code menu field 444 by highlighting the code and selecting the right arrow button 448. Conversely, the user may remove ICD9 codes from the ICD9 selection field 446 by highlighting the code and selecting the left arrow button 447.

Upon selection of a desired ICD9 code by the user, the anatomic user interface 58 continues to a block 220 where the selected ICD9 code is added to the current diagnosis details field 407. More specifically, both a written description of the diagnosis and the ICD9 code for the diagnosis are added to the current diagnosis details order field 407. Next, in a decision block 222, the anatomic user interface 58 determines if the user has selected another ICD9 code for the selected anatomic structure. Those of ordinary skill in the medical arts will recognize that any anatomic structure may be associated with more than one medical diagnosis. Accordingly, blocks 218 and 220, and perhaps 214 and 216, are repeated for each ICD9 code selected by the user.

When the user is finished selecting the desired ICD9 codes, the logic proceeds to a decision block 224 where it determines if the user has selected the CPT code option from the menu 412. If not, decision block 224 is merely repeated until the user makes such a selection. Once selected, the logic proceeds to a block 226 where the anatomic user interface 58 sends the user's ICD9 code selections to the constraint engine 82 residing on the application server 38. As will be discussed in more detail below in connection with FIG. 10, the constraint engine 82 takes the user's ICD9 code selections and returns to the anatomic user interface 58 only those CPT codes that are valid for or “constrained to” those ICD9 codes. In other words, for a particular group of diagnoses, the constraint engine 82 returns only those healthcare services that are appropriate for treating such diagnoses. Consequently, the user is allowed to order only those healthcare services that are appropriate for the medical diagnoses associated with the anatomic structure to be treated and the user is only allowed to order those healthcare services using the proper CPT codes assigned to those services. As a result, once the order for the healthcare services is placed with the service provider and rendered for payment with the appropriate payer, e.g., the patient's insurance company, the order should not be rejected based upon improper coding or based upon improper assignment of healthcare services to medical diagnoses. In other embodiments of the present invention, the constraint engine 82 may apply additional and/or different constraints to the healthcare information being accessed according to the type of healthcare information and other outside elements which impact accepted medical practice such as regulatory compliance, legal compliance, etc. For example, if drug treatment information is being accessed, the set of valid drug treatments for a particular anatomic structure may be further constrained by the regulations of the Food and Drug Administration or the criminal laws of a particular jurisdiction.

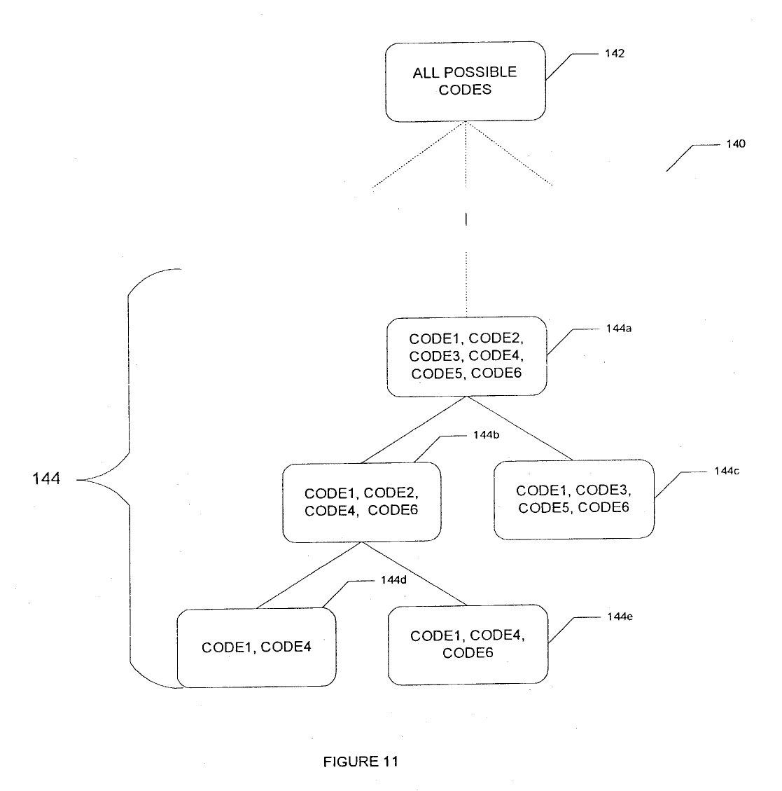

The logic implemented by the constraint engine 82 to constrain ICD9 codes to CPT codes is shown in more detail in FIG. 10. The logic of FIG. 10 begins in a block 300 and proceeds to a block 302 where the constraint engine 82 creates a diagnosis group consisting of all of the ICD9 codes selected by the user. Once a diagnosis group is created, it is compared against a constraint tree 140 shown in FIG. 11. The constraint tree 140 is stored in mass memory 78 of the application server 38. The constraint tree comprises a root node 142 containing the set of all possible ICD9 codes. The constraint tree 140 then includes a plurality of child nodes 144. Each child node 144 contains a subset of ICD9 codes. For example, if root node 142 includes the set of all possible ICD9 codes, then root node 142 may eventually have a child node 144a which includes a subset of six ICD9 codes such as code 1, code 2, code 3, code 4, code 5 and code 6. Child node 144a, in turn, may have two additional child nodes 144b and 144c, each containing a further subset of the ICD9 codes found in node 144a. For example, node 144b includes three ICD9 codes: code 1, code 2 and code 6, while node 144c contains four ICD9 codes: code 1, code 3, code 5 and code 6. In turn, node 144b may have two child nodes 144d and 144e. Node 144d includes a subset of those codes found in node 144b, namely, code 1 and code 4. Node 144e, on the other hand, includes a subset of node 144b having three codes: code 1, code 4 and code 6. As described in more detail below, the constraint engine 82 compares the diagnosis group containing the user's ICD9 codes to the constraint tree 140 until it finds a node within the constraint tree 140 that contains the smallest subset of codes that match the diagnosis group, i.e., until it finds the node with the “best fit.” The logic for this comparison is depicted in FIG. 10 in blocks 304-322.

More specifically, after the constraint engine 82 creates a diagnosis group in a block 302, the constraint engine 82 sets the current node (which is the node to be compared to the diagnosis group) to the root node of the constraint tree 140. Next, in a block 306, the first child node 144 of the current node is obtained from the constraint tree. In a decision block 308, the diagnosis group is compared to the child node to determine if the diagnosis group contains a set of ICD9 codes that is a proper subset of the ICD9 contained in the child node. If so, the constraint engine 82 proceeds to a block 310 where it computes a mismatch number for the child node. In one actual embodiment of the present invention, the mismatch number is computed as the number of codes contained in the child node in addition to the subset of codes that match the diagnosis group. For example, if the child node contains a subset of codes that matches exactly the codes of the diagnosis group, the mismatch number for the child node will be 0. In turn, if the child node contains one additional code that is not part of the subset found in the diagnosis group, the mismatch number for the child node is 1, and so on. In yet other embodiments of the present invention, the mismatch number is computed based on the number of extra codes found in the child node and on a statistical weighting placed on certain codes, thereby providing additional criteria for which to determine the child with the best fit for the diagnosis group.

Returning to decision block 308, if the diagnosis group is not a proper subset of any of the codes found in the child node, then the child node is no longer considered. Consequently, the logic skips block 310 and proceeds directly to a decision block 312 where the constraint engine 82 determines if the last child of the current node has been compared to the diagnosis group. If not, the logic proceeds to a block 314 in which the next child of the current node is obtained from the constraint tree 140. Blocks 308 through 312 are then repeated for each child of the current node. Consequently, for each child node of the current node that includes at least the same set of codes as the diagnosis group, a mismatch number for the child node is computed. For each child node that does not include at least the same set of codes as the diagnosis group, the child node is dismissed from further consideration by skipping the calculation of a mismatch number. When the last child of the current node has been compared to the diagnosis group in decision block 312, the constraint engine 82 proceeds to a decision block 316 in which it determines whether the diagnosis group formed a proper subset of any of the child nodes of the current node. If not, then the current node of the constraint tree 144 is the best fit for the diagnosis group and thus, is used to return the appropriate CPT codes to the anatomic user interface 58 as will be described in more detail below.

Returning to decision block 316, if the diagnosis group contained a proper subset of at least one of the child nodes of the current node, then the constraint engine 82 proceeds to a decision block 318 where it determines if the diagnosis group contained a proper subset of more than one child node of the current node. If so, the current node is set to the child node with the smallest mismatch number in a block 322. In other words, the current node is set to the child node in the current level of the constraint tree, which contains the best fit for the diagnosis group.

Returning to decision block 318, if the diagnosis group is a proper subset of only one child node of the current node, then there may be a better fit for the diagnosis farther down the constraint tree 140. Accordingly, the constraint engine 82 proceeds to a block 320 where the current node is set to the child node of the current level of the constraint tree 140 and blocks 306 through 322 are repeated for each child of the newly set current node. Consequently, the constraint tree 140 will be traversed by the constraint engine until the child node 144 that best fits the diagnosis group is found. Once found, the constraint engine 82 proceeds to a block 324 where an instantiation of a diagnostic procedure constraint object 154 which constrains a group of ICD9 codes to a group of CPT codes is returned to the anatomic user interface 58.

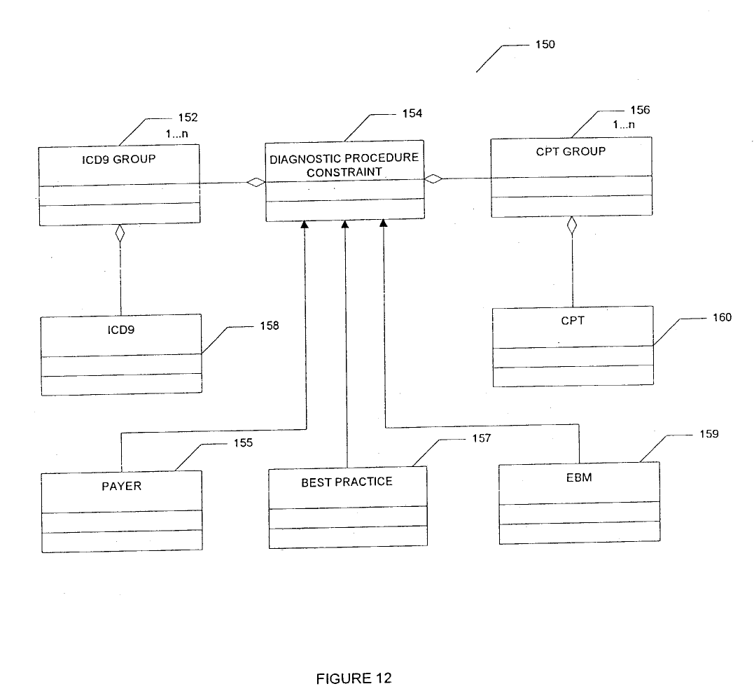

A diagnostic procedure constraint object 154 links or constrains ICD9 codes to CPT codes. The diagnostic procedure constraint object 154 forms part of the diagnostic procedure constraint model 150 that is shown in FIG. 12. The model provides a look-up mechanism that allows identification of CPT codes from a set of one or more ICD9 codes and the anatomic structure selected during the anatomic drill down. The diagnostic procedure constraint object 154 forms the base class for the model 150 and includes the data and methods necessary for implementing a constraint relationship between an ICD9 group object 152 and a CPT group object 156. The ICD9 group object 152 includes a plurality of ICD9 objects 158, wherein each ICD9 object contains a specific ICD9 code. Similarly, the CPT group object 156 can be divided into a plurality of procedure objects 160, each of which defines a specific CPT code.

This constraint relationship states that for a group of ICD9 codes, there is a set of valid CPT codes. As an example, if the ICD9 group contained the entire ICD9 code set, then the corresponding CPT group would contain the entire CPT code set. However, the constraint relationship is normally much narrower. The diagnostic procedure constraint object 154 recognizes the fact that an anatomic structure such as the musculo/skeletal structure of the index finger of the right hand can be subject to multiple disease conditions which require different diagnostic testing and treatment. However, the diagnostic procedure constraint object 154 also recognizes that only certain diagnostic tests and treatments are appropriate for a given set of disease conditions. Narrowing down a specific clinical problem to a particular anatomic structure will only eliminate largely unrelated ICD9 and CPT codes from the user's consideration. The constraint engine 82 and the diagnostic procedure constraint object 154 are then needed to eliminate the rest of the inappropriate CPT codes from consideration. For example, when the anatomic structure of the right hand is selected, the diseases of the gastro/intestinal tract are eliminated from consideration. Thus, once a subset of possible ICD9 codes is selected for a fracture of the index finger of the right hand, then the CPT codes not related to the diagnosis and treatment of the fracture are eliminated from consideration by the diagnostic procedure constraint object 154 returned by the constraint engine 82.

In yet other embodiments of the present invention, a diagnostic procedure constraint 154 can also have relationships to other constraints. In one actual embodiment, CPT codes and ICD9 codes are further constrained by payer constraints, best practice constraints and evidence based medicine (“EBM”) constraints. Accordingly, the diagnostic procedure constraint object 154 of the diagnostic procedure constraint model 154 may be divided into further subclasses including a payer constraint object 155, a best practice constraint object 157 and an EBM constraint object 159. Accordingly, when the constraint engine 82 returns an instantiation of the diagnostic procedure constraint object 154 to the anatomic user interface 58, it also returns instantiations of the payer, best practice and EBM constraint objects.

The payer constraint object 155 includes the data and methods necessary for defining the payment constraints a payer places on ordering healthcare services, such as refusal to reimburse, or reimbursing only for certain services. Payer constraints are payer specific since each insurer decides independently which services for which they will pay. Accordingly, the payer constraint object 155 returned to the anatomic user interface 58 will correspond to the payer identified in the patient's record stored in the patient database 97 and will identify those services by CPT code for which it will pay.

The best practice constraint object 157 includes the data and methods necessary for defining a particular service provider's best practice policies. In other words, it allows a service provider, such as a hospital, clinic, etc. where the service is to be performed, to select those healthcare services it feels are best for a specific group of diagnoses. Accordingly, the best practice constraint object 157 returned to the anatomic user interface 58 will correspond to the service provider identified in the patient's record stored in the patient database 97 and will identify those services by CPT code it prefers to provide.

Finally, the EBM constraint object 159 includes the data and methods necessary for defining which healthcare services should be provided according to the best available clinical science. Accordingly, the EBM constraint object 159 will be returned to the anatomic user interface 58 if the user has previously indicated a desire to see such a constraint when beginning the order as identified in the patient's record stored in the patient database 97. The EBM constraint object will identify those services by CPT code that are considered optimal in light of the current clinical setting (which may include additional coding such as SNOMED).

It will be appreciated that different or additional constraints may be applied to the healthcare information being accessed by the user without departing from the scope of the present invention. For example, patient information available through the anatomic model 402 could be used as a further constraint on healthcare services, such as not allowing consideration of Magnetic Resonance if the patient has an artificial cardiac pacing device. This patient-specific constraint can avoid contra-indicated or dangerous tests based on each patient's unique conditions.

Returning to block 324 of FIG. 10, once the node of the constraint tree 140 containing the best fit for the diagnosis group of ICD9 codes selected by the user is found by the constraint engine 82, the constraint engine 82 returns an instantiation of the diagnostic procedure constraint object 154 which contains the group of CPT codes that are constrained to the user's selected ICD9 codes, as well as further payer, best practice and EBM constraints. The constraint engine ends in a block 326.

Returning to FIG. 5C, once the anatomic user interface 58 receives the diagnostic procedure constraint from the constraint engine and thus, receives the constraint CPT codes, the anatomic user interface proceeds to a block 230 where a CPT tab 450, including a CPT code menu field 452 listing the constrained CPT codes is displayed to the user as shown in FIG. 4G in a Web page 428. The user is then allowed to select from the CPT code menu 452 the CPT codes he or she chooses by highlighting the code and moving it to a CPT order field 446 using the right arrow button 448. As with the ICD9 codes, the user must sometimes navigate a series of CPT menus to drill down to the desired CPT code. Accordingly, once a CPT code selection is received by the anatomic user interface 58 in a block 232, the anatomic user interface 58 determines in a decision block 234 if the selected CPT code contains any subcodes. If so, blocks 230 and 232 are repeated to provide the user with a submenu for the selected CPT code containing its CPT subcodes in the CPT code menu field 452. Once the user drills down to the desired CPT code, the CPT code is added to the order field 408 in a block 236. In on actual embodiment of the present invention, once a CPT code is added to the order field 408, service specific information is retrieved from the anatomic database 42 and displayed for response by the user. For example, if a Magnetic Resonance exam (“MR”) is ordered, the user may be requested to provide answers to questions such as does the patient have a pacer, artificial heart valve, etc.? Such information will then be logged with the order and forwarded to the service provider for use when administering the service.

Next, the anatomic user interface 58 determines in a decision block 238 if the user has selected another CPT code. If so, blocks 234 though 238 are repeated for each CPT code selected by the user. Once the user has selected as many CPT codes as he or she desires, the anatomic user interface 58 proceeds to a decision block 239 in which it determines whether there are any other constraints on the ICD9 and CPT codes selected. In other words, the anatomic user interface 58 determines if there were payer, best practice, or EBM constraints returned by the constraint engine 82 along with the diagnostic procedure constraint. If so, the user is allowed in block 241 to modify the order by removing and/or adding the ICD9 and CPT codes recommended by the additional payer, best practice or EMB constraints via the ICD9 tab 430 and the CPT tab 450. After the order has been modified or if there are no other constraints on the user's selections, the anatomic user interface 58 sends an order for the selected CPT codes in a block 243 to the order engine 86 along with the ICD9 codes associated with the selected CPT codes. The anatomic user interface 58 then ends in a block 244.

The logic implemented by the order engine 86 to process the order received from the anatomic user interface 58 is shown in more detail in FIG. 13. The order engine begins in a block 330 and proceeds to a block 332 where the order is received from the anatomic user interface 58. Next, the order engine 86 determines in a decision block 334 if preauthorization is required from the payer for the order. As noted above, an ordered healthcare service can further be constrained by payer constraints, best practice constraints or EBM constraints. A payer constraint associated with an ordered healthcare service may require preauthorization. Consequently, the result of decision block 334 will be positive and the order engine 86 will obtain the payer's preauthorization requirements. In one actual embodiment of the present invention, preauthorization requirements are obtained from the payer by submitting a Health Level 7 (“HL7”) transaction request to a computer server operated by the payer. Those of ordinary skill in the art will recognize that the Health Level 7 communication protocol is a medical industry accepted standard protocol for electronic submission of medical payment and information requests. Next, in a decision block 338, the order engine 86 determines if the payer has requested additional information from the user in response to the HL7 transaction. If so, the order engine requests the additional information from the user in a block 340. In one actual embodiment of the present invention, an e-mail containing the request for additional information is sent to the user. In yet other embodiments of the present invention, the order engine sends the request in the form of a Web page provided to the user computer 30 and displayed by the Web browser 54.

Once additional information is obtained or if it is not required, the order engine 86 obtains a response for preauthorization from the payer in a block 342 (typically in the form of another HL7 transaction). Next, decision block 344 the order engine determines if the payer has approved the order. If not, the user is notified in a block 346 (e.g., via e-mail, fax, Web browser, etc.). If preauthorization approval is obtained from the payer or if it is not required, the order engine 86 proceeds to a block 346 where it sends the order to the service provider in the form of another HL7 transaction. Next, in a decision block 348 the order engine 86 determines if service provider has accepted the order. If so, the order engine notifies the patient's physician so that the physician can inform the patient in a block 352 (e.g., via e-mail, fax, Web browser, etc.). If the order is not accepted, the user is notified in a block 350. Once notification of the physician and/or user is complete, the order engine ends in a block 354.

While the preferred embodiment of the invention has been illustrated and described, it will be appreciated that various changes can be made therein without departing from the spirit and scope of the invention. For example, although in one actual embodiment of the present invention, the anatomic user interface 58 is used to access medical diagnoses and related healthcare services information, it will be appreciated by those of ordinary skill in the art the anatomic user interface 58 may be used to access any type of healthcare information as it relates to the human anatomy. For instance, the animated user interface 58 may be used to review test results, determine a patient's medical condition, query medical resources about specific conditions, etc. Since the anatomic user interface 58 is medically focused, rather than code focused, virtually any coding scheme can be programmed into the anatomic data model and diagnostic procedure constraint model to provide the user with appropriate healthcare information for a particular anatomic structure.

The embodiments of the invention in which an exclusive property or privilege is claimed are defined as follows:

1. A computer-readable medium having a computer-executable component for enabling a user to access healthcare information, the computer-executable component comprising:
an anatomic user interface for displaying an anatomic model from which the user selects an anatomic structure of interest, wherein upon selection of the anatomic structure, the anatomic user interface displays the healthcare information that is associated with the selected anatomic structure.

2. The computer-readable medium of claim 1, wherein the anatomic user interface displays only that healthcare information associated with the selected anatomic structure and a context for accessing the healthcare information, and automatically eliminates from the display that healthcare information that is irrelevant thereto.

3. The computer-readable medium of claim 2, wherein the context for accessing the healthcare information is defined by the type of healthcare information.

4. The computer-readable medium of claim 3, wherein the type of healthcare information is based on at least a predetermined medical specialty.

5. The computer-readable medium of claim 2, wherein the context for accessing the healthcare information is defined by at least a patient's medical history.

6. The computer-readable medium of claim 2, wherein the context for accessing the healthcare information is defined by at least a predetermined organ system.

7. The computer-readable medium of claim 1, wherein the anatomic model is comprised of a plurality of anatomic substructures through which the user drills down to select the anatomic structure of interest.

8. The computer-readable medium of claim 1, having a further computer-executable component comprising an anatomic data model for providing the anatomic user interface with anatomic information used to display an anatomic model for a particular patient, wherein the anatomic information comprises:
standard reference information describing the normal human anatomy; and
patient-specific information describing differences between the normal human anatomy and the anatomy of a particular patient.

9. The computer-readable medium of claim 8, having a further computer-executable component comprising a data management system for adding, modifying, and deleting healthcare information stored in the anatomic data model.

10. The computer-readable medium of claim 8, wherein the healthcare information includes medical history information, medical services ordered, and medical services rendered.

11. The computer-readable medium of claim 8, having a further computer-executable component comprising an anatomic data model for providing the anatomic user interface with healthcare information that is associated with the selected anatomic structure.

12. The computer-readable medium of claim 11, having a further computer-executable component comprising a constraint engine for constraining the healthcare information associated with the selected anatomic structure by at least one predetermined healthcare constraint and returning the constrained healthcare information to the anatomic user interface.

13. The computer-readable medium of claim 12, wherein the anatomic user interface displays the constrained healthcare information to the user for selection.

14. The computer-readable medium of claim 12, wherein the at least one predetermined healthcare constraint is another type of healthcare information.

15. The computer-readable medium of claim 12, wherein the at least one predetermined healthcare constraint is a regulatory requirement.

16. The computer-readable medium of claim 12, wherein the at least one predetermined healthcare constraint is a medical practice constraint.

17. The computer-readable medium of claim 1, wherein the healthcare information comprises healthcare diagnosis and service information.

18. (New) The computer-readable medium of claim 17, wherein the healthcare diagnosis information is identified by International Classification of Disease codes and the healthcare services information is identified by Common Procedure Terminology codes.

19. The computer-readable medium of claim 17, wherein, upon selection of the anatomic structure of interest, the anatomic user interface displays a group of possible healthcare diagnoses associated with the selected anatomic structures from which the user selects at least one healthcare diagnosis.

20. The computer-readable medium of claim 19, wherein, upon selection of said at least one healthcare diagnosis, a constraint engine identifies at least one healthcare service that is constrained by the selected at least one healthcare diagnosis and the selected anatomic structure and provides the at least one healthcare service to the anatomic user interface.

21. The computer-readable medium of claim 20, wherein the constraint engine identifies the at least one healthcare service constrained by:
comparing the selected at least one healthcare diagnosis to each node of a constraint tree having a root node representing all possible healthcare diagnoses and at least one other node representing a subset of healthcare diagnoses, wherein the selected at least one healthcare diagnosis is compared to each node of the constraint tree until a node is found with a subset of healthcare diagnoses that best matches the selected at least one healthcare diagnosis; and
returning to the anatomic user interface the at least one healthcare service that is constrained by the subset of healthcare diagnoses that best matches the selected at least one healthcare diagnosis.

22. The computer-readable medium of claim 20, wherein the anatomic user interface displays the at least one healthcare service to the user for selection.

23. The computer-readable medium of claim 20, wherein the constraint engine constrains the at least one healthcare service by a payor constraint.

24. The computer-readable medium of claim 20, wherein the constraint engine constrains the at least one healthcare service by a best-practice constraint.

25. The computer-readable medium of claim 20, wherein the constraint engine constrains the at least one healthcare service by an evidence-based medical constraint.

26. The computer-readable medium of claim 20, having a further computer-executable component comprising an order engine for submitting an order to a service provider for the at least one healthcare service returned by the constraint engine and selected by the user.

27. The computer-readable medium of claim 26, wherein the order engine automatically adds the order to the healthcare information stored in the anatomic data model.

28. The computer-readable medium of claim 26, wherein the order engine automatically incorporates healthcare information stored in the anatomic data model into the order.

29. The computer-readable medium of claim 26, wherein the order engine submits the order to the service provider for the at least one healthcare service by:
obtaining authorization for the order from the payor, if necessary;
sending the order to the service provider; and
notifying the user if the order is not accepted by the service provider or if authorization for the order is not received from the payor.

30. The computer-readable medium of claim 26, wherein the order engine automatically notifies the user if the order is accepted by the service provider or if the authorization for the order is received from the payor.

31. The computer-readable medium of claim 26, wherein the order engine notifies the user electronically using a separate communications channel.

32. A method for accessing healthcare information for a patient, the method comprising:
displaying an anatomic model of the patient;
using the anatomic model to drill down to and select an anatomic structure of the patient; and
displaying healthcare information associated with the selected anatomic structure.

33. The method of claim 32, wherein displaying healthcare information associated with the selected anatomic structure includes automatically eliminating from the display that healthcare information that is irrelevant thereto.

34. The method of claim 32, further comprising adding, modifying, and deleting healthcare information stored in the anatomic data model.

35. The method of claim 32, wherein the healthcare information includes medical history, medical services ordered, and medical services rendered.

36. The method of claim 32, wherein using the anatomic model to drill down to and select an anatomic structure of the patient comprises:
selecting an organ system of interest;
displaying the organ system applied to the anatomic model of the patient; and
selecting an anatomic structure of the patient from the anatomic model applied with the organ system.

37. The method of claim 32, further comprising:
if the selected anatomic structure has further anatomic substructures, displaying the anatomic substructures of the selected anatomic structure for the user's selection, wherein the anatomic model and the anatomic structures displayed represent the actual anatomy of the patient.

38. The method of claim 32, wherein displaying the healthcare information associated with the selected anatomic structure comprises:
retrieving the healthcare information associated with the selected anatomic structure;
constraining the healthcare information according to at least one healthcare constraint; and
displaying the constrained healthcare information.

39. The method of claim 38, wherein the at least one healthcare constraint is another type of healthcare information.

40. The method of claim 38, wherein the at least one healthcare constraint is a regulatory requirement.

41. The method of claim 38, wherein the at least one healthcare constraint is a payor constraint.

42. The method of claim 38, wherein the at least one healthcare constraint is a best-practice constraint.

43. The method of claim 38, wherein the at least one healthcare constraint is an evidence-based medical constraint.

44. The method of claim 32, wherein the healthcare information comprises healthcare diagnosis and service information.

45. The method of claim 44, wherein displaying healthcare information associated with the selected anatomic structure comprises:
at least one healthcare diagnosis associated with the selected anatomic structure;
identifying at least one healthcare service constrained by said at least one healthcare diagnosis; and
displaying the constrained at least one healthcare service.

46. The method of claim 45, wherein identifying said at least one healthcare service constrained by said at least one healthcare diagnosis comprises:
comparing said at least one healthcare diagnosis to each node of a constraint tree having a root node representing a set of healthcare diagnoses and at least one other node representing a subset of healthcare diagnoses, wherein said at least one healthcare diagnosis is compared to each node of the constraint tree until a node is found with a subset of the healthcare diagnoses that best matches said at least one healthcare diagnosis; and
identifying at least one healthcare service that is associated with the subset of healthcare diagnoses that best matches said at least one healthcare diagnosis.

47. The method of claim 45, further comprising identifying at least one healthcare service constrained by a payor constraint.

48. The method of claim 45, further comprising identifying at least one healthcare service constrained by a best-practice constraint.

49. The method of claim 45, further comprising identifying at least one healthcare service constrained by an evidence-based medical constraint.

50. The method of claim 45, further comprising submitting an order to a service provider for at least one constrained healthcare service selected by the user.

51. The method of claim 50, further comprising automatically adding the order to the healthcare information stored in the anatomic data model.

52. The method of claim 50, further comprising automatically incorporating healthcare information stored in the anatomic data model into the order.

53. The method of claim 50, wherein submitting an order for the selected at least one constrained healthcare service to a service provider comprises:
obtaining authorization for the order from the payor, if necessary;
sending the order to the service provider; and
notifying the user if the order is not accepted by the service provider or if authorization for the order is not received from the payor.

54. The method of claim 53, wherein the user is further notified if the order is accepted by the service provider or if the authorization for the order is received from the payor.

55. The method of claim 53, wherein notifying the user is performed electronically using a separate communications channel.

56. A computer-readable medium containing instructions that, when executed by a computer, perform the method of claim 53.

57. A computer-controlled apparatus for performing the method of claim 53.

58. A system for accessing healthcare information comprising:
a user computer operative to:
display an anatomic model of the patient;
enable the user to drill down to and select an anatomic structure of the patient from a higher-level anatomic model; and
display healthcare information associated with the selected anatomic structure; and
an application server operative to:
receive the selected anatomic structure from the user computer; and
provide the user computer with the healthcare information associated with the selected anatomic structure for display.

59. The system of claim 58, wherein the display of healthcare information associated with the selected anatomic structure includes healthcare information associated with the purpose of accessing the healthcare information and eliminates healthcare information that is irrelevant thereto.

60. The system of claim 58, wherein the user computer is further operative to add, modify, and delete healthcare information stored in the anatomic data model.

61. The system of claim 58, wherein the healthcare information includes medical services ordered and rendered.

62. The system of claim 58, wherein the user computer and the application server are operatively connected via an internetwork.

63. The system of claim 62, wherein the healthcare information comprises healthcare diagnosis and service information.

64. The system of claim 63, wherein the application server provides the user computer with the healthcare information associated with the selected anatomic structure by:
retrieving at least one healthcare diagnosis associated with the selected anatomic structure from an anatomic data model;
identifying at least one healthcare service constrained by said at least one healthcare diagnosis; and
providing the user computer with the constrained at least one healthcare service.

65. The system of claim 64, wherein the application server identifies said at least one healthcare service constrained by said at least one healthcare diagnosis by:
comparing said at least one healthcare diagnosis to each node of a constraint tree having a root node representing a set of healthcare diagnoses and at least one other node representing a subset of healthcare diagnoses, wherein said at least one healthcare diagnosis is compared to each node of the constraint tree until a node is found with a subset of the healthcare diagnoses that best matches said at least one healthcare diagnosis; and
identifying at least one healthcare service that is associated with the subset of healthcare diagnoses that best matches said at least one healthcare diagnosis.

66. The system of claim 64, wherein the application server further identifies said at least one healthcare service by applying a payor constraint to said at least one healthcare service.

67. The system of claim 64, wherein the application server further identifies said at least one healthcare service by applying a best-practice constraint to said at least one healthcare service.

68. The system of claim 64, wherein the application server further identifies said at least one healthcare service by applying an evidence-based medical constraint to said at least one healthcare service.

69. The system of claim 58, wherein the user computer is further operative to:
enable the user to select an organ system of interest;
display the organ system applied to the anatomic model of the patient; and
enable the user to drill down to and select an anatomic structure of the patient from the higher-level anatomic model applied with the organ system.

70. The system of claim 58, wherein the user computer is further operative to:
if the selected anatomic structure has further anatomic substructures, display the anatomic substructures of the selected anatomic structure, wherein the anatomic model and the anatomic structures displayed represent the actual anatomy of the patient.

71. The system of claim 58, wherein the application server provides the user computer with the healthcare information associated with the selected anatomic structure by:
retrieving the healthcare information associated with the selected anatomic structure from an anatomic data model;
constraining the healthcare information according to at least one healthcare constraint; and
providing the user computer with the constrained healthcare information.

72. The system of claim 71, wherein the at least one healthcare constraint is another type of healthcare information.

73. The system of claim 72, wherein the application server is further operative to submit an order to a service provider for at least one constrained healthcare service selected by the user.

74. The system of claim 73, wherein the application server is further operative to automatically add the order to the healthcare information stored in the anatomic data model.

75. The system of claim 73, wherein the application server is further operative to automatically incorporate healthcare information into the order.

76. The system of claim 71, wherein the at least one healthcare constraint is a regulatory requirement.

77. The system of claim 71, wherein the at least one healthcare constraint is a payor constraint.

78. The system of claim 71, wherein the at least one healthcare constraint is a best-practice constraint.

79. The system of claim 71, wherein the at least one healthcare constraint is an evidence-based medical constraint.

80. The system of claim 73, wherein the application server submits an order for the selected at least one constrained healthcare service to a service provider by:
obtaining authorization for the order from the payor, if necessary;
sending the order to the service provider; and
notifying the user if the order is not accepted by the service provider or if authorization for the order is not received from the payor.

81. The system of claim 80, wherein the application server further notifies the user if the order is accepted by the service provider or if the authorization for the order is received from the payor.

82. The system of claim 80, wherein the application server notifies the user electronically using a separate communications channel.

83. The system of claim 80, wherein the application server submits the order to the service provider via an internetwork.

84. The computer-readable medium of claim 1, wherein the anatomic user interface further displays a menu of anatomic terms corresponding to anatomic structures of the anatomic model and wherein the user selects the anatomic structure of interest from the menu of anatomic terms.

85. The computer-readable medium of claim 1, wherein the anatomic user interface further displays a menu of healthcare terms corresponding to anatomic structures of the anatomic model and wherein the user selects the healthcare term of interest from the menu.

86. The method of claim 32, wherein using the anatomic model to drill down to and select an anatomic structure of the patient comprises:
displaying a menu of anatomic terms corresponding to anatomic structures of the anatomic model of the patient; and
selecting an anatomic structure from the menu of anatomic terms.

87. The method of claim 36, wherein selecting an organ system of interest comprises:
displaying an organ system menu; and
selecting an organ system of interest from the organ system menu.

88. The system of claim 58, wherein the user computer enables the user to drill down to and select an anatomic structure of the patient from a higher-level anatomic model by:
displaying a menu of anatomic terms corresponding to anatomic structures of the anatomic model of the patient; and
selecting an anatomic structure from the menu of anatomic terms.

89. The system of claim 69, wherein the user computer enables the user to select an organ system of interest by:
displaying an organ system menu; and
selecting an organ system of interest from the organ system menu.
